(19) United States
(12) Patent Application Publication
(10) Pub. No.: US 2018/0100104 A1
(43) Pub. Date: Apr. 12, 2018

(54) LIQUID CRYSTALLINE MEDIUM

(71) Applicant: MERCK PATENT GMBH, Darmstadt (DE)

(72) Inventors: Mark GOEBEL, Winchester (GB); Rocco FORTTE, Frankfurt (DE); Lars LIETZAU, Rossdorf (DE); Christian HOCK, Mainaschaff (DE)

(73) Assignee: MERCK PATENT GMBH, Darmstadt (DE)

(21) Appl. No.: 15/558,815

(22) PCT Filed: Mar. 3, 2016
(86) PCT No.: PCT/EP2016/000372

§ 371 Date: Sep. 15, 2017

(30) Foreign Application Priority Data
Mar. 18, 2015 (DE) 10 2015 003 602.5

(51) Int. Cl. C09K 19/34; C09K 19/42

(52) U.S. Cl. CPC C09K 19/3491; C09K 2019/0466; C09K 19/42; C09K 19/3483

(57) ABSTRACT

The present invention relates to liquid-crystalline media (LC media), characterised in that they comprise one or more compounds of the formula I,

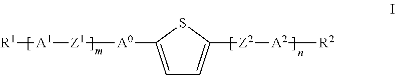

and one or more compounds of the formula II,

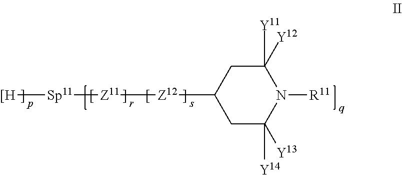

where the parameters have the meaning indicated in claim 1, to the use thereof in electro-optical displays, and to LC displays which contain these LC media.

The present invention relates to liquid-crystalline media (LC media) comprising thiophene derivatives which are stabilised by sterically hindered amines or amine derivatives (HALS, hindered amine light stabilisers), and to liquid-crystal displays (LC displays) which contain these LC media.

Liquid crystals are used principally as dielectrics in display devices, since the optical properties of such substances can be modified by an applied voltage. Electro-optical devices based on liquid crystals are extremely well known to the person skilled in the art and can be based on various effects. Examples of such devices are cells having dynamic scattering, DAP (deformation of aligned phases) cells, guest/host cells, TN cells having a twisted nematic structure, STN (supertwisted nematic) cells, SBE (super-birefringence effect) cells and OMI (optical mode interference) cells. The commonest display devices are based on the Schadt-Helfrich effect and have a twisted nematic structure. In addition, there are also cells which work with an electric field parallel to the substrate and liquid-crystal plane, such as, for example, IPS (in-plane switching) cells.

The principle of electrically controlled birefringence, the ECB (electrically controlled birefringence) effect or DAP (deformation of aligned phases) effect, was described for the first time in 1971 (M. F. Schieckel and K. Fahrenschon, “Deformation of nematic liquid crystals with vertical orientation in electrical fields”, Appl. Phys. Lett. 19 (1971), 3912). Papers by J. F. Kahn (Appl. Phys. Lett. 20 (1972), 1193) and G. Labrunie and J. Robert (J. Appl. Phys. 44 (1973), 4869) followed.

The papers by J. Robert and F. Clerc (SID 80 Digest Techn. Papers (1980), 30), J. Duchene (Displays 7 (1986), 3) and H. Schad (SID 82 Digest Techn. Papers (1982), 244) have shown that liquid-crystalline phases must have high values for the ratio between the elastic constants K₃/K₁, high values for the optical anisotropy Δn, and values for the dielectirc anisotropy Δε of ≤−0.5 in order to be suitable for use for high-information display elements based on the ECB effect. Electro-optical display elements based on the ECB effect have a homeotropic edge alignment (VA technology=vertically aligned). Dielectrically negative liquid-crystal media can also be used in displays which use the IPS or FFS effect.

TN, VA, IPS and FFS cells, in particular, are currently areas of application of commercial interest for the media according to the invention.

The liquid-crystal materials must have good chemical and thermal stability and good stability to electric fields and electromagnetic radiation. Furthermore, the liquid-crystal materials should have low viscosity and give rise to short addressing times, low threshold voltages and high contrast in the cells.

They should furthermore have a suitable mesophase, for example a nematic mesophase for the above-mentioned cells, at the usual operating temperatures, i.e. in the broadest possible range above and below room temperature. Since liquid crystals are generally used as mixtures of a plurality of components, it is important that the components are readily miscible with one another. Further properties, such as the electrical conductivity, the dielectric anisotropy and the optical anisotropy, have to satisfy various requirements depending on the cell type and area of application. For example, materials for cells having a twisted nematic structure should have positive dielectric anisotropy and low electrical conductivity.

For example, for matrix liquid-crystal displays with integrated non-linear elements for switching individual pixels (MLC displays), media having large positive dielectric anisotropy, broad nematic phases, relatively low birefringence, very high specific resistance, good UV and temperature stability and low vapour pressure are desired.

Matrix liquid-crystal displays of this type are known. Examples of non-linear elements which can be used to individually switch the individual pixels are active elements (i.e. transistors). The term “active matrix” is then used, where a distinction can be made between two types:
1. MOS (metal oxide semiconductor) or other diodes on silicon wafers as substrate.
2. Thin-film transistors (TFTs) on a glass plate as substrate.

The TFT matrix is applied to the inside of one glass plate of the display, while the other glass plate carries the transparent counterelectrode on its inside. Compared with the size of the pixel electrode, the TFT is very small and has virtually no adverse effect on the image. This technology can also be extended to fully colour-capable displays, in which a mosaic of red, green and blue filters is arranged in such a way that a filter element is opposite each switchable pixel.

The TFT displays usually operate as TN cells with crossed polarisers in transmission and are backlit.

The term MLC displays here encompasses any matrix display with integrated non-linear elements, i.e., besides the active matrix, also displays with passive elements, such as varistors or diodes (MIM=metal-insulator-metal).

MLC displays of this type are particularly suitable for TV applications (for example pocket televisions) or for high-information displays for computer applications (laptops) and in automobile or aircraft construction. Besides problems regarding the angle dependence of the contrast and the response times, difficulties also arise in MLC displays due to insufficiently high specific resistance of the liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, pp. 141 ff, Paris; STROMER, M., Proc. Eurodisplay 84, Sept. 1984: Design of Thin Film Transistors for Matrix Addressing of Television Liquid Crystal Displays, pp. 145 ff, Paris]. With decreasing resistance, the contrast of an MLC display deteriorates, and the problem of after-image elimination may occur. Since the specific resistance of the liquid-crystal mixture generally drops over the life of an MLC display owing to interaction with the interior surfaces of the display, a high (initial) resistance is very important in order to obtain acceptable lifetimes. In particular in the case of low-volt mixtures, it was hitherto impossible to achieve very high specific resistance values. It is furthermore important that the specific resistance exhibits the smallest possible increase with increasing temperature and after heating and/or UV exposure. The MLC displays from the prior art thus do not satisfy today's requirements.

For TV and video applications, MLC displays having short response times are required. Such short response times can be achieved, in particular, if liquid-crystal media having low values for the viscosity, in particular the rotational viscosity γ₁, are used. However, diluting additives generally lower the clearing point and thus reduce the working-temperature range of the medium.

Thus, there continues to be a great demand for MLC displays having very high specific resistance at the same time as a large working-temperature range, short response times, even at low temperatures, and a low threshold voltage which do not exhibit these disadvantages or only do so to a lesser extent.

In the case of TN (Schadt-Helfrich) cells, media are desired which facilitate the following advantages in the cells:
extended nematic phase range (in particular down to low temperatures)
ability to switch at extremely low temperatures (outdoor use, automobiles, avionics)
increased resistance to UV radiation (longer life)
low threshold voltage.

Using the media available from the prior art, backlight is not possible to achieve these advantages while simultaneously retaining the other parameters.

The prior art, for example the specifications WO 2010/099853 A1 and DE 10 2010 027 099 A1, discloses thiophene-containing LC media. WO 2010/099853 A1 discloses compounds containing a thiophene-2,5-diyl unit which is linked directly to a 2- and/or 6-substituted 1,4-phenylene unit. The object on which WO 2010/099853 A1 was based was the development of novel materials for use in LC displays. This object was achieved by the provision of compounds of the general formula

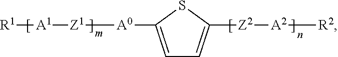

where A⁰ denotes a 2,6-difluoro-1,4-phenylene unit, A¹ and A², besides other meanings, denote a 1,4-phenylene or 1,4-cyclohexylene unit, and Z¹ and Z² denote a bridging element or a single bond. Specific examples described are, for example, the following compounds (see WO 2010/099853 A1):

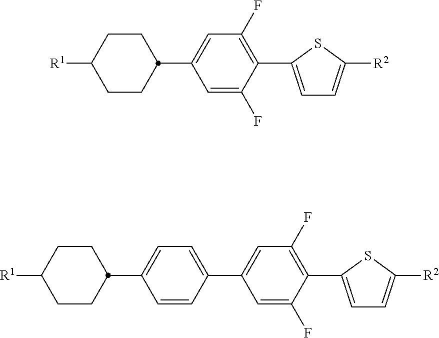

For many practical applications in liquid-crystal displays, the known liquid-crystalline media comprising thiophene compounds are not sufficiently stable. In particular, exposure to UV radiation, but also even irradiation with the usual backlighting, results in an impairment, in particular of the electrical properties. Thus, for example, the conductivity increases significantly.

DE 10 2010 027 099 A1 describes LC media which comprise the compounds disclosed in WO 2010/099853 and bithienyl derivatives of the formula

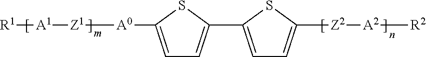

as stabiliser. These bithienyl derivatives are preferably employed here in combination with thiophene 1,1-dioxide derivatives of the formula

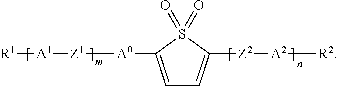

In both the above formulae, A¹ and A² denote, for example, 1,4-phenylene or 1,4-cyclohexylene and Z¹ and Z², besides other meanings, denote, for example, a single bond. Specific examples described are the following compounds (see DE 10 2010 027 099 A1):

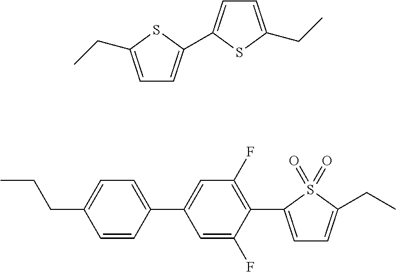

The use of so-called “hindered amine light stabilisers”, HALS for short, has already been proposed for the stabilisation of liquid-crystal mixtures.

HALS with various substituents on the nitrogen atom are compared with respect to their pK_{B} values in Ohkatsu, Y., J. of Japan. Petroleum Institute, 51, 2008, pages 191-204. The following types of structural formulae are disclosed there.

| Type | Active group of the stabiliser |
|---|---|
| “HALS” | 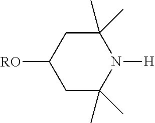 |
| “R-HALS” or “NR-HALS” | 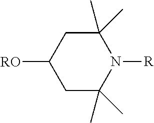 |
| “NOR-HALS” | 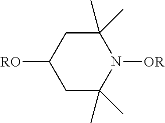 |

The compound TEMPOL, of the following formula:

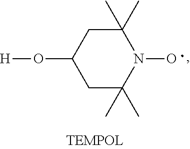

is known; it is mentioned, for example, in Miéville, P. et al., Angew. Chem. 2010, 122, pages 6318-6321. It is commercially available from various manufacturers and is employed, for example, as polymerisation inhibitor and, in particular in combination with UV absorbers, as light or UV protection in formulations for precursors of polyolefins, polystyrenes, polyamides, coatings and PVC.

DE 102011117937.6 describes liquid-crystal mixtures having negative dielectric anisotropy which comprise TINUVIN® 770, a compound of the formula

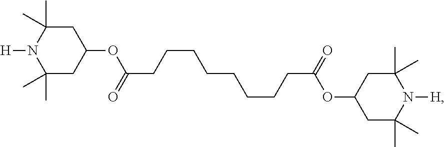

for stabilisation.

DE 102011119144.9 and PCT/EP2011/005692 describe liquid-crystal mixtures which comprise, inter alia, HALS N-oxides for stabilisation.

Nematic liquid-crystal mixtures having negative dielectric anisotropy which comprise a small amount of TINUVIN® 770 as stabilisers are also proposed, for example, in WO 2009/129911 A1. However, the corresponding liquid-crystal mixtures in some cases have inadequate properties for some practical applications. Inter alia, they sometimes do not have adequate stability against exposure to irradiation by typical CCFL (cold cathode fluorescent lamp) backlight or exhibit problems with the LTS (low-temperature stability).

The use of various stabilisers in liquid-crystalline media is described, for example, in JP (S)55-023169 (A), JP (H)05-117324 (A), WO 02/18515 A1 and JP (H) 09-291282 (A).

TINUVIN® 123, a compound of the formula

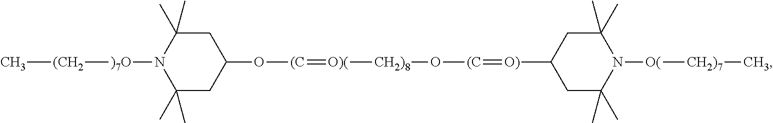

has also been proposed for stabilisation purposes.

Mesogenic compounds containing one or two HALS units are disclosed in EP 1 1784 442 A1.

The complexity of the mechanisms of action and the fact that LC media are composed of up to ten or even more individual substances which are chemically different from one another result in the choice of a suitable light stabiliser being extremely difficult, even for the person skilled in the art, in view of the multiplicity of available materials.

It was an object of the invention to provide media, in particular for TN, VA or IPS displays of this type, which have the desired properties indicated above and do not exhibit the disadvantages indicated above, or only do so to a lesser extent. In particular, the LC media should have fast response times and low rotational viscosities at the same time as high dielectric anisotropy and high birefringence. In addition, the LC media should have a high clearing point, a broad nematic phase range and a low threshold voltage.

A further object of the invention was to provide thiophene-containing LC media which do not exhibit the disadvantages mentioned above, or only do so to a small extent.

Surprisingly, it has been found that the objects indicated above can be achieved by using thiophene derivatives in combination with HALS in LC media, in particular in LC media in LC displays with active addressing, and in TN, VA, IPS or FFS displays. The combination of thiophene derivatives with HALS indicated below results in LC media having the desired properties indicated above.

On the basis of the prior art, the person skilled in the art would not have expected that the use of thiophene derivatives according to the invention in nematic LC media having an inherently untwisted phase, in particular in LC media having positive dielectric anisotropy, and in TN, VA, IPS or FFS displays, with addition of HALS as light stabilisers can result in an improvement in the properties, i.e. in particular in fast response times and low rotational viscosities at the same time as high dielectric anisotropy, high birefringence and high specific resistance with excellent light stability.

The present invention thus relates to an LC medium, characterised in that it comprises one or more compounds of the formula I

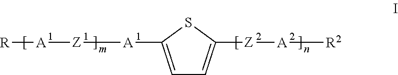

in which the individual radicals have the following meanings:
R¹ and R² denote H, F, CI, Br, —CN, —SCN, —NCS, SF₅ or straight-chain or branched alkyl having 1 to 12 C atoms, in which, in addition, one or more non-adjacent CH₂ groups may each be replaced, independently of one another, by —CH═CH—, —C≡C—, —O—, —CO—, —CO—O—, —O—CO—, —O—CO—O— in such a way that O atoms are not linked directly to one another, and in which, in addition, one or more H atoms may be replaced by F, CI or Br, where R¹ and R² preferably denote alkyl,
A⁰, A¹ and A² each, independently of one another, denote phenylene-1,4-diyl, in which, in addition, one or two CH groups may be replaced by N and one or more H atoms may be replaced by halogen, CN, CH₃, CHF₂, CH₂F, CF₃, OCH₃, OCHF₂ or OCF₃, cyclohexane-1,4-diyl, in which, in addition, one or two non-adjacent CH₂ groups may be replaced, independently of one another, by O and/or S and one or more H atoms may be replaced by F, cyclohexene-1,4-diyl, bicyclo[1.1.1]pentane-1,3-diyl, bicyclo[2.2.2]octane-1,4-diyl, spiro-[3.3]heptane-2,6-diyl, tetrahydropyran-2,5-diyl or 1,3-dioxane-2,5-diyl, where A⁰ preferably denotes 2,6-difluoro-1,4-phenylene and A¹ preferably denotes 1,4-cyclohexylene, 1,4-phenylene, 2-fluoro-1,4-phenylene, particularly preferably 1,4-phenylene,
Z¹ and Z² each, independently of one another, denote —CF₂O—, —OCF₂—, —CH₂O—, —OCH₂—, —CO—O—, —O—CO—, —C₂H₄—, —C₂F₄—, —CF₂CH₂—, —CH₂CF₂—, —CFHCFH—, —CFHCH₂—, —CH₂CFH—, —CF₂CFH—, —CFHCF₂—, —CH═CH—, —CF═CH—, —CH═CF—, —CF═CF—, —C≡C— or a single bond, and
m and n each, independently of one another, denote 0, 1, 2 or 3, where m+n is preferably 1, 2 or 3, particularly preferably 1,
   and one or more compounds of the formula II,

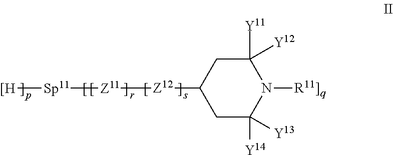

in which
q denotes 1 or 2,
p denotes (2-q),
Z¹¹ and Z¹², independently of one another, denote —O—, —(C═O)— or a single bond, but do not both simultaneously denote —O—,
r and s, independently of one another, denote 0 or 1,
Y¹¹ to Y¹⁴ each, independently of one another, denote alkyl having 1 to 4 C atoms and alternatively also, independently of one another, one or both of the pairs (Y¹¹ and Y¹²) and (Y¹³ and Y¹⁴) together denote a divalent group having 3 to 6 C atoms, preferably CH₃,

R¹¹ on each occurrence, independently of one another, denotes H, alkyl, O-alkyl, O-cycloalkyl, —O^{⋅} or —OH,
Sp¹¹ denotes a straight-chain or branched alkyl chain having 2-20 C atoms, in which one or more —CH₂— groups may be replaced by —O—, but two adjacent —CH₂— groups cannot be replaced by —O—, or denotes a hydrocarbon radical which contains a cycloalkyl or alkylcycloalkyl unit and in which one or more —CH₂— groups may be replaced by —O—, but two adjacent —CH₂— groups cannot be replaced by —O—.

The invention furthermore relates to the use of the medium according to the invention in electro-optical devices, in particular in LC displays.

The invention furthermore relates to an LC display containing an LC medium according to the invention, in particular a TN, VA, IPS or FFS display.

Preference is given to media comprising the compounds of the formula I in which A⁰ denotes phenylene-1,4-diyl, in which, in addition, one or two CH groups may be replaced by N and one or more H atoms may be replaced by halogen, CN, CH₃, CHF₂, CH₂F, OCH₃, OCHF₂, CF₃ or OCF₃, particularly preferably in which

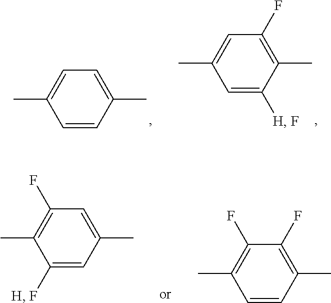

A⁰ denotes
   and very particularly preferably in which

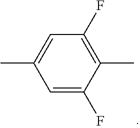

A⁰ denotes

The preferred compounds of the formula I result in media having a particularly high clearing point, low rotational viscosity, a broad nematic phase, high birefringence and good stability.

Preference is furthermore given to compounds of the formula I in which m and n denote 0, 1 or 2, particularly preferably 0 or 1. Particular preference is given to compounds of the formula I in which n denotes 0, i.e. the thiophene ring is a terminal ring. Preference is furthermore given to compounds of the formula I in which m denotes 0, 1 or 2, preferably 1 or 2 and very particularly preferably 1.

A¹ and A² in formula I particularly preferably denote phenylene-1,4-diyl, which may also be mono- or polysubstituted by F, furthermore cyclohexane-1,4-diyl, tetrahydropyran-2,5-diyl or 1,3-dioxane-2,5-diyl.

Z¹ and Z² in formula I particularly preferably denote —CF₂O—, —OCF₂— or a single bond, in particular a single bond.

A¹ and A² in formula I particularly preferably denote

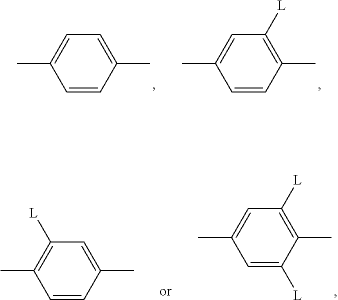

preferably unsubstituted 1,4-phenylene, in which L denotes halogen, CF₃ or CN, preferably F.

Preference is furthermore given to compounds of the formula I in which R¹ and R² each, independently of one another, denote H, F, CI, Br, —CN, —SCN, —NCS, SF₅, halogen, or alkyl, alkenyl or alkynyl having 1 to 8, preferably 1 to 5, C atoms, each of which is optionally substituted by halogen, in particular by F.

Particularly preferred radicals R¹ and R² in formula I denote H, halogen, or alkyl, alkenyl, alkynyl or alkoxy having 1 to 12, preferably 1 to 8, C atoms, each of which is optionally substituted by halogen, in particular by F, particularly preferably H, F, alkyl, alkenyl or alkynyl having 1 to 8 C atoms. Preferably, at least one radical is not H, particularly preferably both radicals R¹ and R² are not H. R¹ is very particularly preferably equal to alkyl. R² is furthermore preferably H, alkyl or fluorine. Very particularly preferably, R¹ is alkyl and R² is H or alkyl. R¹, R² each, independently of one another, very particularly preferably denote unbranched alkyl having 1-5 C atoms. If R¹ and R² denote substituted alkyl, alkoxy, alkenyl or alkynyl, the total number of C atoms in the two groups R¹ and R² is preferably less than 10.

Preferred alkyl groups are, for example, methyl, ethyl, n-propyl, n-butyl, n-pentyl, n-hexyl, n-heptyl and n-octyl.

Preferred alkenyl groups are, for example, ethenyl, propenyl, butenyl and pentenyl.

Preferred alkynyl groups are, for example, ethynyl, propynyl, butynyl, pentynyl, hexynyl, heptynyl and octynyl.

Preferred alkoxy groups are, for example, methoxy, ethoxy, n-propoxy, n-butoxy, n-pentoxy, n-hexoxy, n-heptoxy, n-octoxy.

Halogen preferably denotes F or Cl.

Particularly preferred compounds of the formula I are those selected from the following sub-formulae:

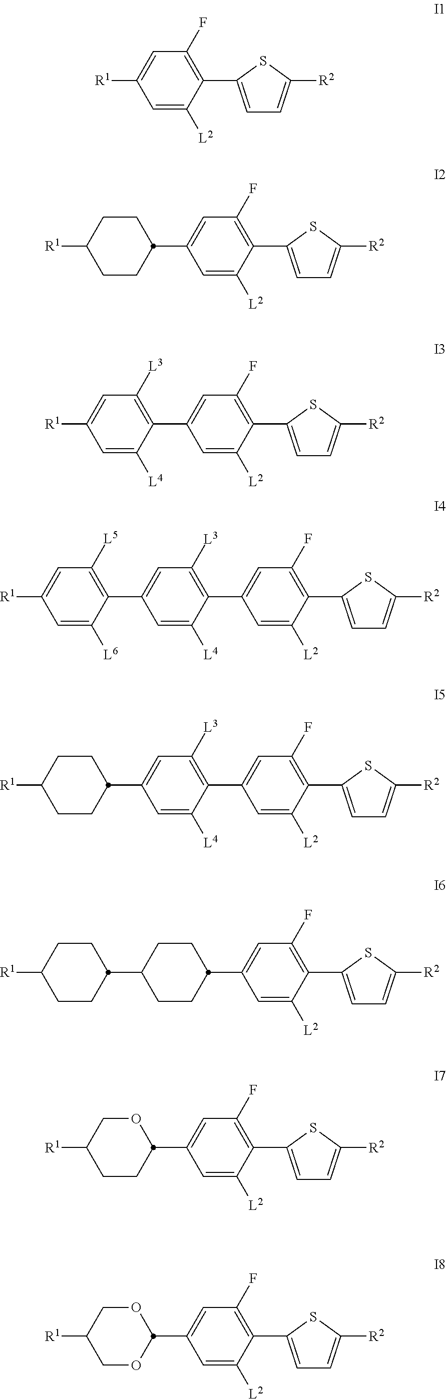

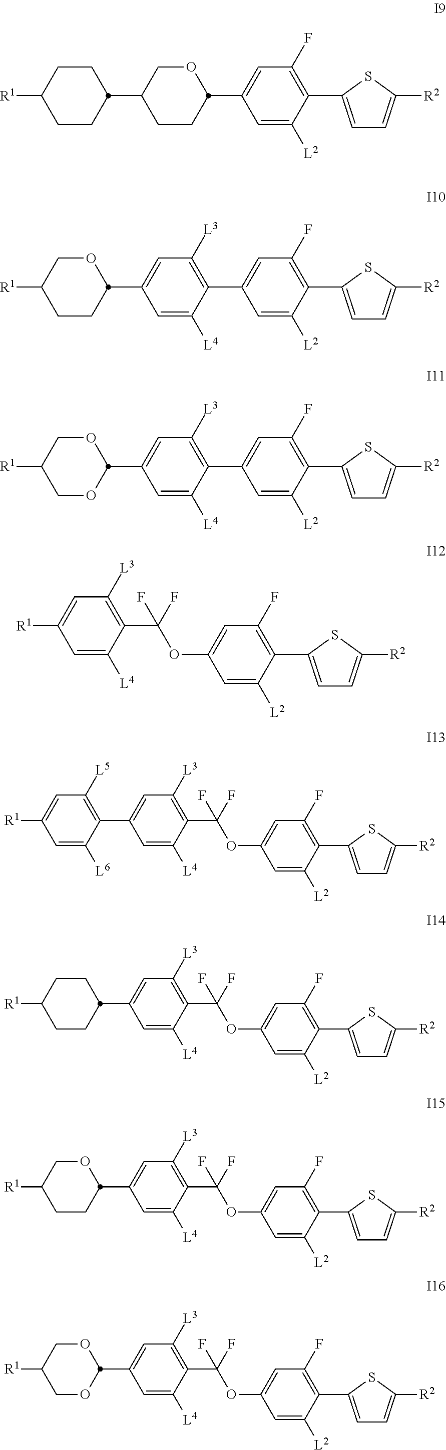

in which R¹ and R² have the meanings indicated above and below, and L¹ to L⁶ independently denote H or F. R¹ and R² therein preferably denote optionally fluorinated alkyl, alkenyl, alkynyl or alkoxy having 1 to 12 C atoms, particularly preferably optionally fluorinated alkyl, alkenyl or alkynyl having 1 to 5 C atoms. L² in the formulae preferably denotes F. In the formulae I3 to I11, L³ and L⁴ preferably denote H. In the formulae I12 to I16, L³ and L⁴ preferably denote F. Preferred media according to the invention comprise compounds selected from the formulae I3 and I5.

The compounds of the formula I can be prepared analogously to processes known to the person skilled in the art and described in standard works of organic chemistry, such as, for example, in Houben-Weyl, Methoden der organischen Chemie [Methods of Organic Chemistry], Thieme-Verlag, Stuttgart.

The synthesis of suitable thiophenes of the formula I is known, for example, from WO 2009/129915 A1, WO 2010/099853 A1 and WO 2010/094455 A1.

Preference is given to media comprising the compounds of the formula II in which n denotes 1, r denotes 1, s denotes 1, Y¹¹, Y¹², Y¹³ and Y¹⁴ denote methyl, R¹¹ denotes H or —O^{⋅}, Z¹¹ denotes C═O and Z¹² denotes O. Preference is furthermore given to media comprising the compounds of the formula II in which n denotes 2, r denotes 1, s denotes 1, Y¹¹, Y¹², Y¹³ and Y¹⁴ denote methyl, R¹¹ denotes H or —O^{⋅}, Z¹¹ denotes C═O and Z¹² denotes O.

Very particularly preferred compounds of the formula II are those selected from the following sub-formulae:

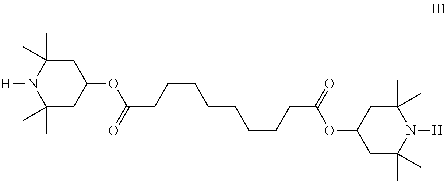

in which L¹⁻³, independently of one another, denote H or F.

The compounds of the formula I can be prepared analogously to processes known to the person skilled in the art and described in standard works of organic chemistry, such as, for example, in Houben-Weyl, Methoden der organischen Chemie [Methods of Organic Chemistry], Thieme-Verlag, Stuttgart.

Particularly preferred LC media according to the invention are indicated below:
LC medium which additionally comprises one or more compounds of the formulae III and/or IV:

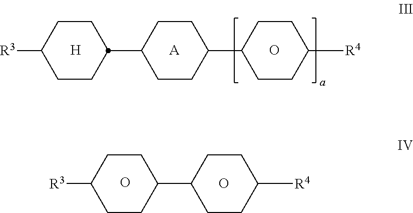

in which
A denotes 1,4-phenylene or trans-1,4-cyclohexylene,
a is 0 or 1,
R³ denotes alkyl or alkenyl having up to 9 C atoms, preferably alkenyl having 2 to 9 C atoms, and
R⁴ denotes alkyl having 1 to 12 C atoms, where, in addition, one or two non-adjacent CH₂ groups may be replaced by —O—, —CH═CH—, —CO—, —O—CO— or —CO—O— in such a way that O atoms are not linked directly to one another, and preferably denotes alkyl having 1 to 12 C atoms or alkenyl having 2 to 9 C atoms.
The compounds of the formula III are preferably selected from the group consisting of the following formulae:

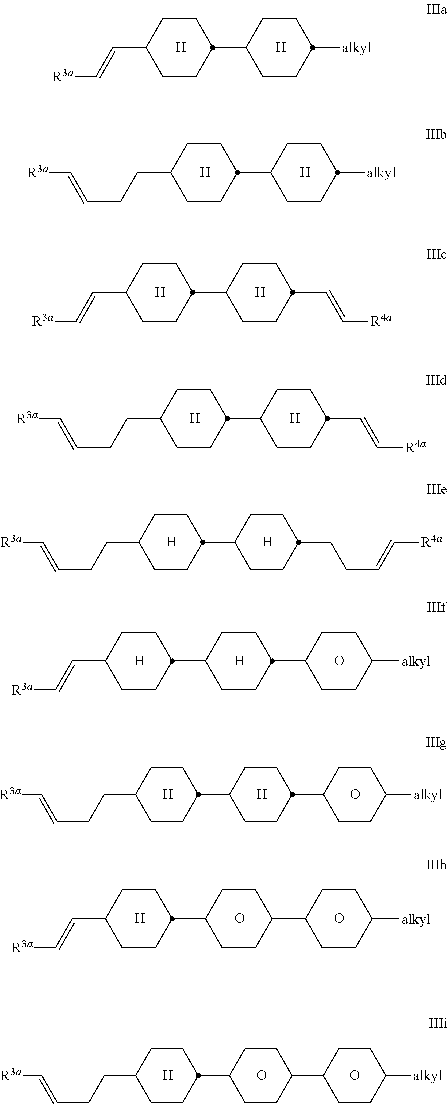

in which R^{3a} and R^{4a} each, independently of one another, denote H, CH₃, C₂H₅ or C₃H₇, and “alkyl” denotes a straight-chain alkyl group having 1 to 8, preferably 1, 2, 3, 4 or 5, C atoms. Particular preference is given to compounds of the formulae IIIa and IIIf, in particular in which R^{3a} denotes H or CH₃, preferably H, and compounds of the formula IIIc, in particular in which R^{3a} and R^{4a} denote H, CH₃ or C₂H₅.
The compounds of the formula IV are preferably selected from the group consisting of the following formulae:

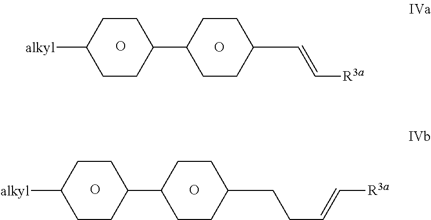

in which “alkyl” and R^{3a} have the meanings indicated above, and R^{3a} preferably denotes H or CH₃. Particular preference is given to compounds of the formula IVb;
LC medium which additionally comprises one or more compounds selected from the group consisting of the following formulae:

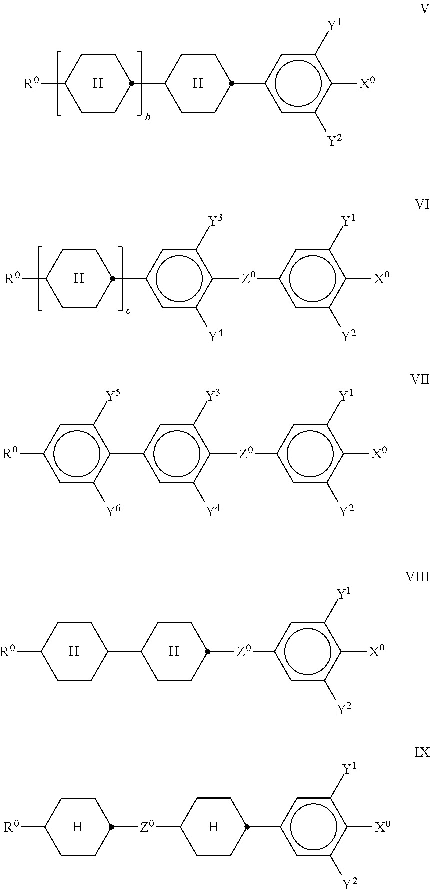

in which
R⁰ denotes an alkyl or alkoxy radical having 1 to 15 C atoms, where, in addition, one or more CH₂ groups in these radicals may each be replaced, independently of one another, by —C≡C—, —CF₂O—, —CH═CH—,

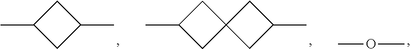

—CO—O— or —O—CO— in such a way that O atoms are not linked directly to one another, and in which, in addition, one or more H atoms may be replaced by halogen,
X⁰ denotes F, CI, CN, SF₅, SCN, NCS, a halogenated alkyl radical, halogenated alkenyl radical, halogenated alkoxy radical or halogenated genated alkenyloxy radical, each having up to 6 C atoms,
Y¹⁻⁶ each, independently of one another, denote H or F,
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO—, —CF₂O— or —OCF₂—, in the formulae V and VI also a single bond, and
b and c each, independently of one another, denote 0 or 1.
In the compounds of the formulae V to IX, X⁰ preferably denotes F or OCF₃, furthermore OCHF₂, CF₃, CF₂H, CI, OCH═CF₂. R⁰ is preferably straight-chain alkyl or alkenyl, each having up to 6 C atoms.
The compounds of the formula V are preferably selected from the group consisting of the following formulae:

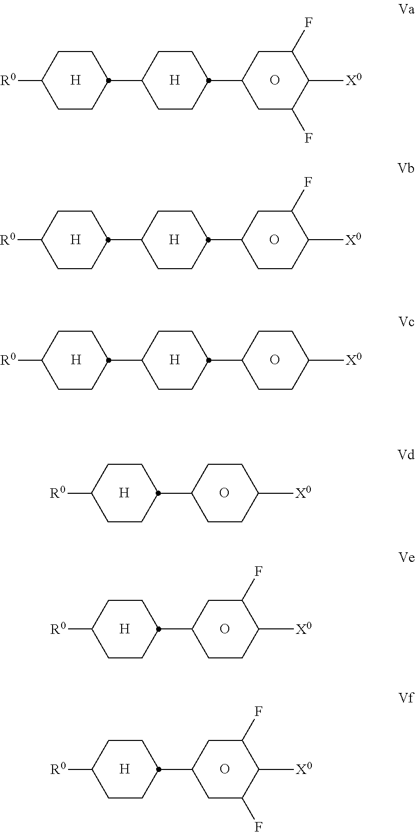

in which R⁰ and X⁰ have the meanings indicated above.
Preferably, R° in formula V denotes alkyl having 1 to 8 C atoms and X⁰ denotes F, CI, OCHF₂ or OCF₃, furthermore OCH═CF₂. In the compound of the formula Vb, R⁰ preferably denotes alkyl or alkenyl. In the compound of the formula Vd, X⁰ preferably denotes CI, furthermore F.
The compounds of the formula VI are preferably selected from the group consisting of the following formulae:

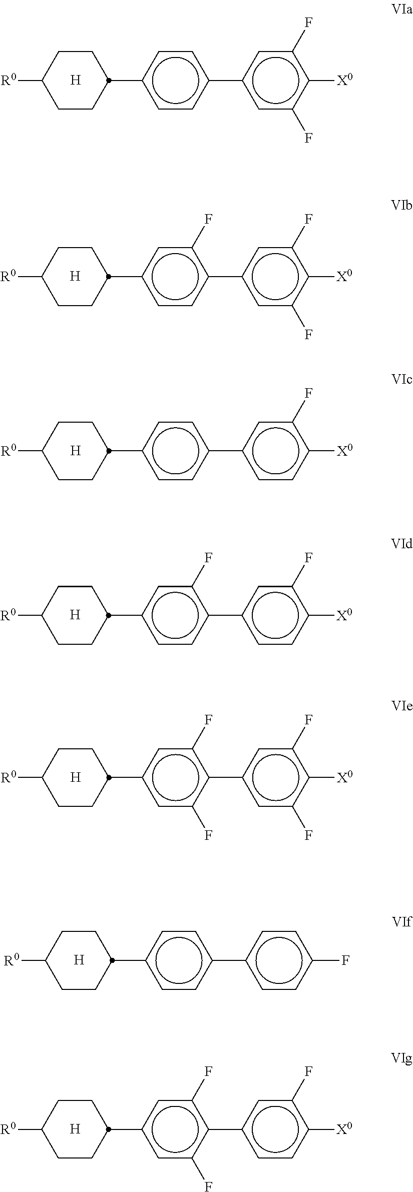

in which R⁰ and X⁰ have the meanings indicated above. Preferably, R⁰ in formula VI denotes alkyl having 1 to 8 C atoms and X⁰ denotes F;
LC medium which comprises one or more compounds of the formula VII-1.

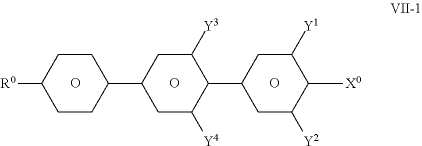

in which Y¹ preferably denotes F, particularly preferably those selected from the group consisting of the following formulae:

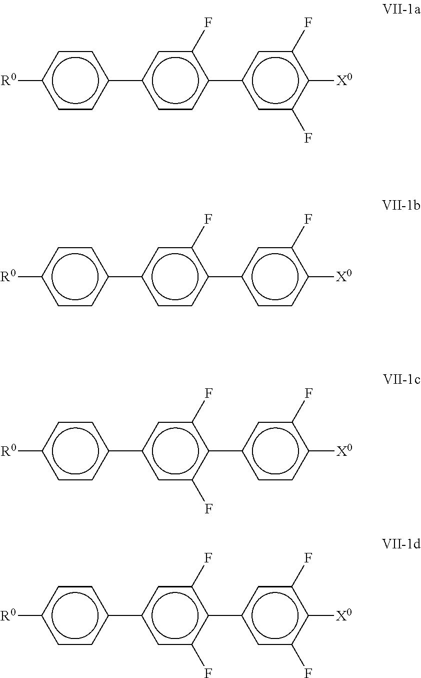

in which R⁰ and X⁰ have the meanings indicated above. Preferably, R⁰ in formula VII denotes alkyl having 1 to 8 C atoms and X⁰ denotes F, furthermore OCF₃.
LC medium which comprises one or more compounds of the formula VII-2:

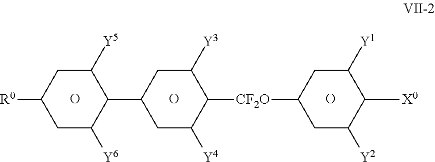

particularly preferably those selected from the group consisting of the following formulae:

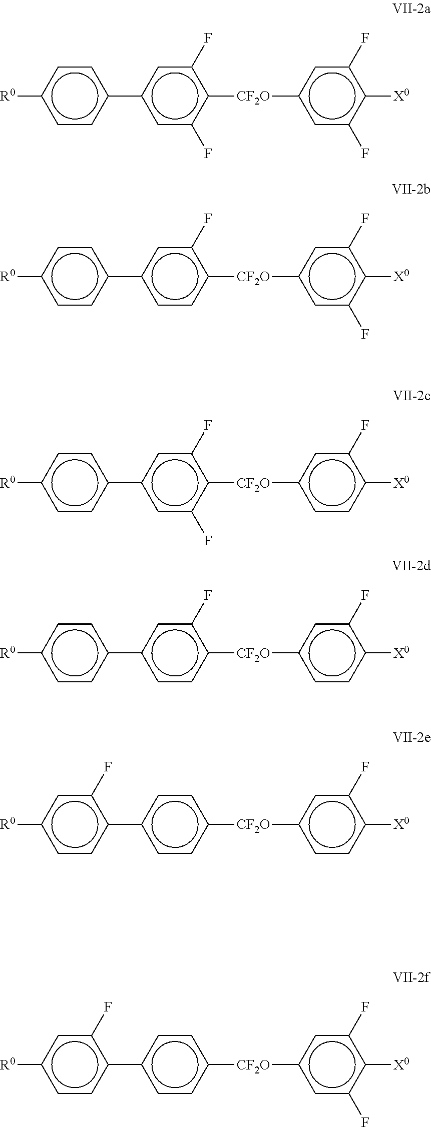

in which R⁰ and X⁰ have the meanings indicated above.
Preferably, R⁰ in formula VII denotes alkyl having 1 to 8 C atoms and X⁰ denotes F;
LC medium which preferably comprises one or more compounds of the formula VIII in which Z⁰ denotes —CF₂O—, —CH₂CH₂— or —COO—, particularly preferably those selected from the group consisting of the following formulae:

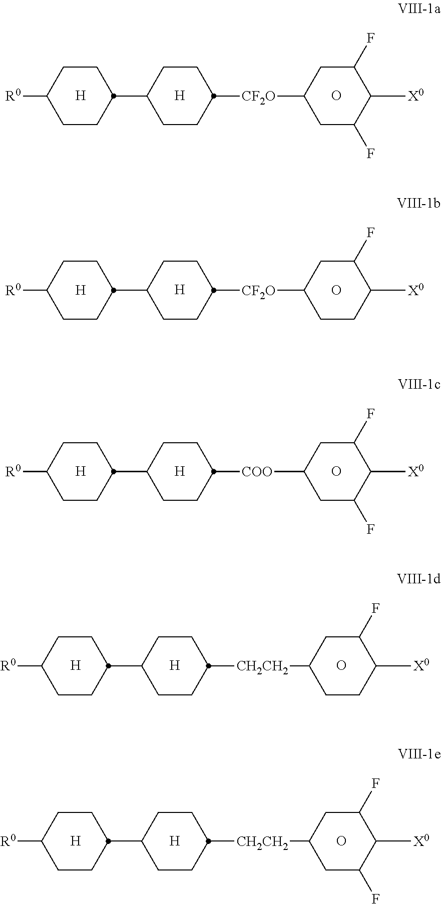

in which R⁰ and X⁰ have the meanings indicated above. Preferably, R⁰ in formula VIII denotes alkyl having 1 to 8 C atoms and X⁰ denotes F, furthermore OCF₃.
The compounds of the formula IX are preferably selected from the group consisting of the following formulae:

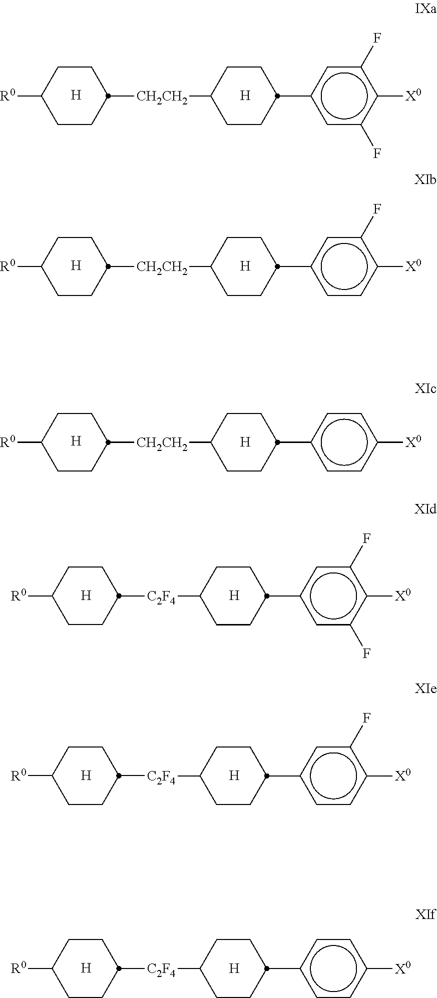

in which R⁰ and X⁰ have the meanings indicated above. R⁰ preferably denotes a straight-chain alkyl radical having 1 to 8 C atoms. X⁰ preferably denotes F.
LC medium which additionally comprises one or more compounds of the following formula:

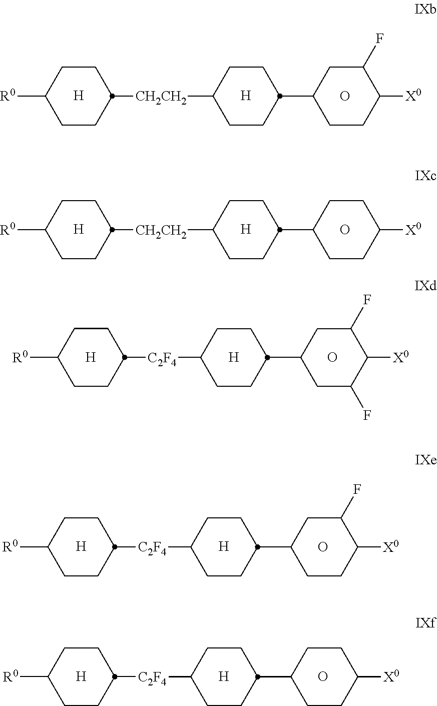

in which R⁰, X⁰, Y¹ and Y² have the meanings indicated above, and

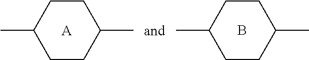

each, independently of one another, denote

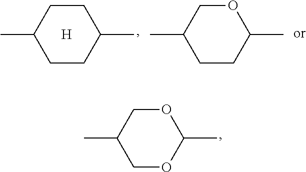

where the rings A and B do not both simultaneously denote cyclohexylene.
The compounds of the formula X are preferably selected from the group consisting of the following formulae:

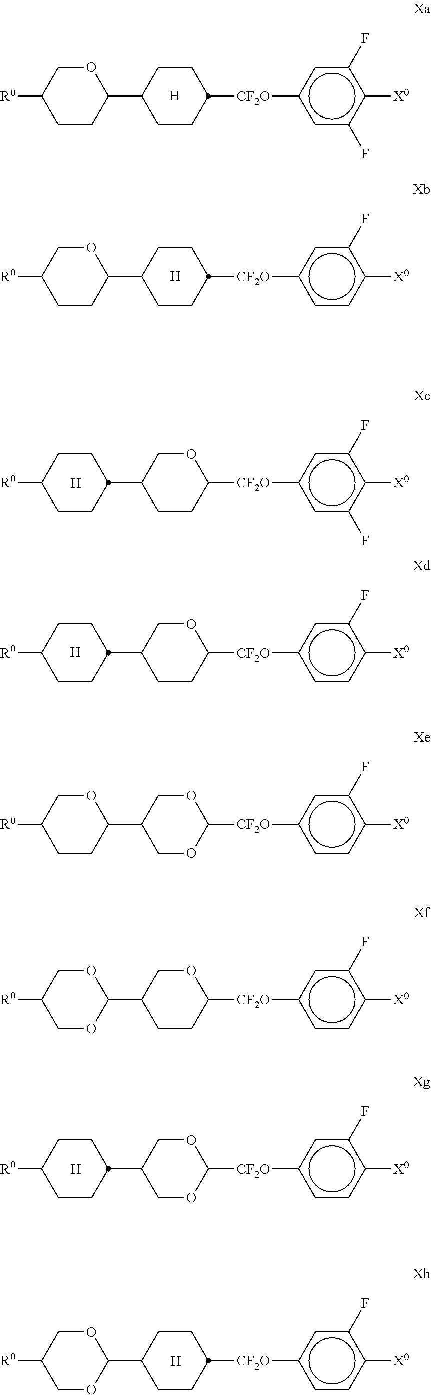

in which R⁰ and X⁰ have the meanings indicated above. Preferably, R⁰ denotes alkyl having 1 to 8 C atoms and X⁰ denotes F. Particular preference is given to compounds of the formula Xa;
LC medium which additionally comprises one or more compounds selected from the group consisting of the following formulae:

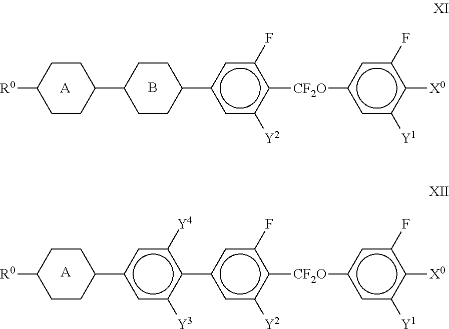

in which R⁰, X⁰ and Y¹⁻⁴ have the meanings indicated above, and

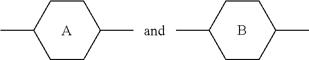

each, independently of one another, denote

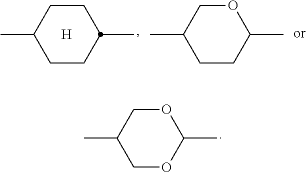

The compounds of the formulae XI and XII are preferably selected from the group consisting of the following formulae:

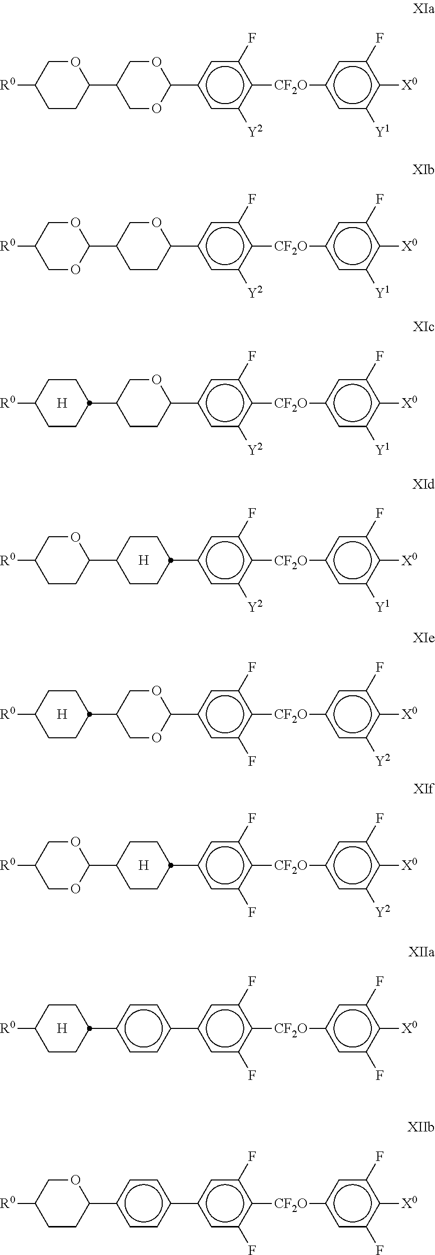

in which R⁰ and X⁰ have the meanings indicated above. Preferably, R⁰ denotes alkyl having 1 to 8 C atoms and X⁰ denotes F. Particularly preferred compounds are those in which Y¹ denotes F and Y² denotes H or F, preferably F;
LC medium which additionally comprises one or more compounds of the following formula:

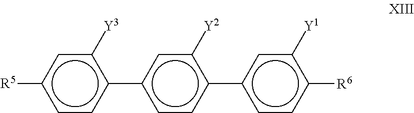

in which R⁵ and R⁶ each, independently of one another, denote n-alkyl, alkoxy, oxaalkyl, fluoroalkyl or alkenyl, each having up to 9 C atoms, and preferably each, independently of one another, denote alkyl having 1 to 8 C atoms. Y¹⁻³, independently of one another, denote H or F. Preferably, one or two of the groups from Y¹⁻³ denote(s) F.
Preferred compounds of the formula XII are those selected from the group consisting of the following formulae:

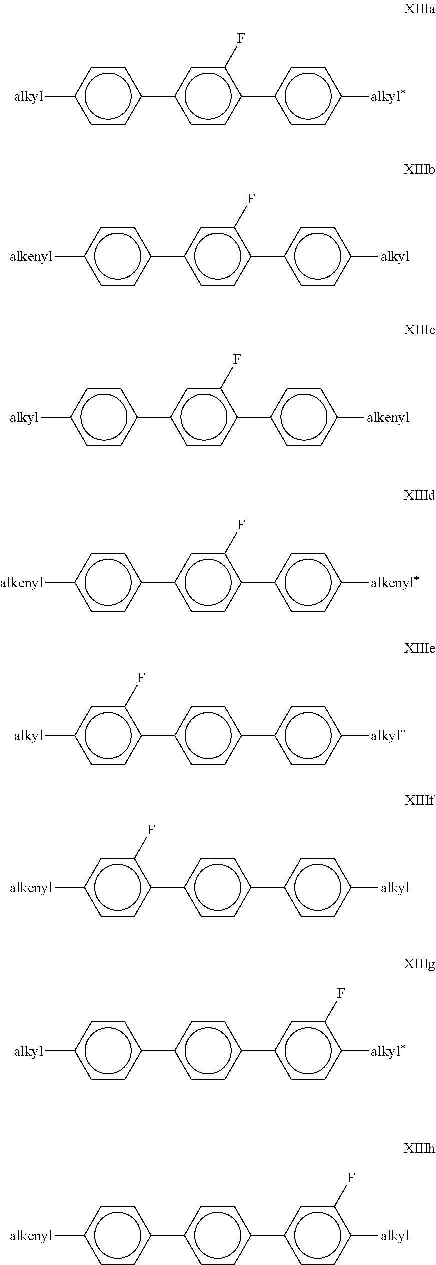

in which
alkyl and alkyl* each, independently of one another, denote a straight-chain alkyl radical having 1 to 6 C atoms, and
alkenyl and
alkenyl* each, independently of one another, denote a straight-chain alkenyl radical having 2 to 6 C atoms.
Very particular preference is given to compounds of the following formula:

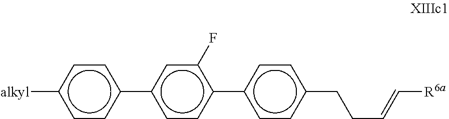

in which alkyl has the meaning indicated above, and R^{6a} denotes H or CH₃.
LC medium which additionally comprises one or more compounds selected from the group consisting of the following formulae:

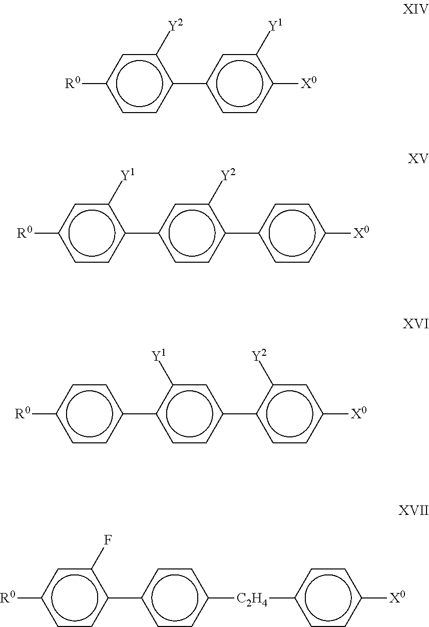

in which R⁰, X⁰, Y¹ and Y² have the meanings indicated above. Preferably, R⁰ denotes alkyl having 1 to 8 C atoms and X⁰ denotes F or Cl.
The compounds of the formulae XIV and XVI are preferably selected from the group consisting of the following formulae:

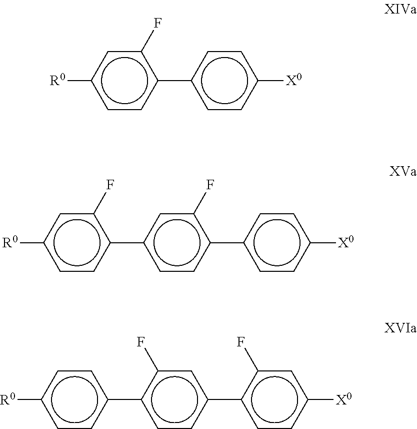

in which R⁰ and X⁰ have the meanings indicated above. R⁰ preferably denotes alkyl having 1 to 8 C atoms and X⁰ preferably denotes F or Cl.
LC medium which additionally comprises one or more compounds of the formulae D1 and/or D2:

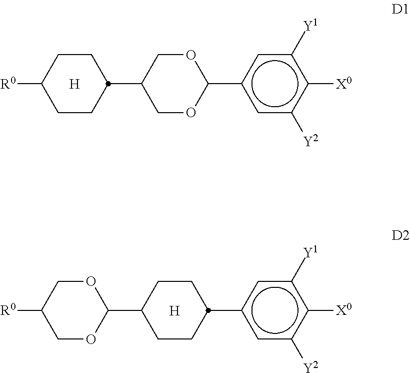

in which Y¹, Y², R⁰ and X⁰ have the meanings indicated above. Preferably, R⁰ denotes alkyl having 1 to 8 C atoms and X⁰ denotes F. Particular preference is given to compounds of the following formulae:

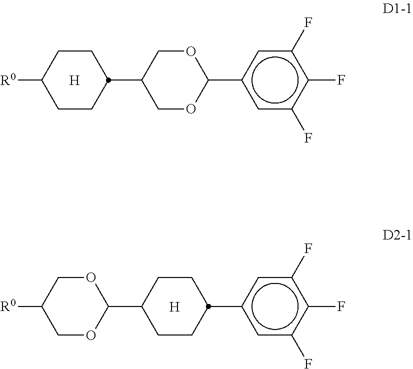

in which R⁰ has the meanings indicated above and preferably denotes straight-chain alkyl having 1 to 6 C atoms, in particular C₂H₅, n-C₃H₇ or n-C₅H₁₁.
LC medium which additionally comprises one or more compounds of the following formula:

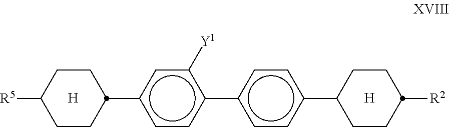

in which Y¹, R¹ and R² have the meanings indicated above. R¹ and R² preferably each, independently of one another, denote alkyl having 1 to 8 C atoms;
LC medium which additionally comprises one or more compounds of the following formula:

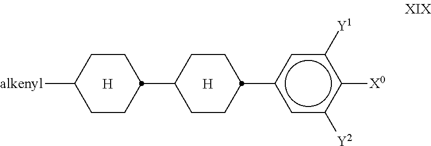

in which X⁰, Y¹ and Y² have the meanings indicated above, and “alkenyl” denotes C₂₋₇-alkenyl. Particular preference is given to compounds of the following formula:

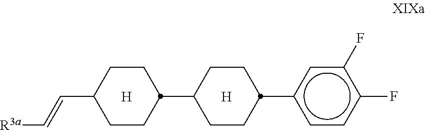

in which R^{3a} has the meaning indicated above and preferably denotes H;
LC medium which additionally comprises one or more tetracyclic compounds selected from the group consisting of the formulae XX to XXVI:

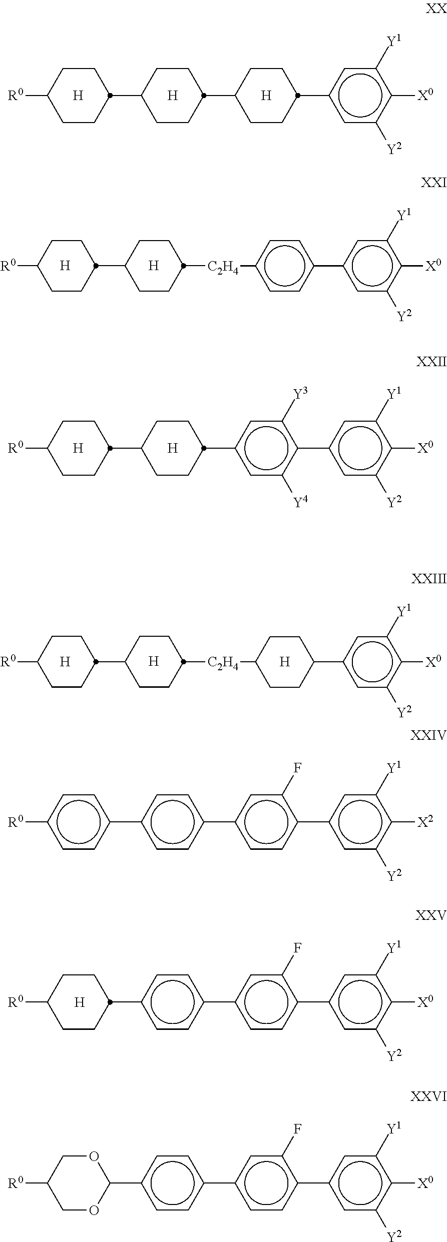

in which Y¹⁻⁴, R⁰ and X⁰ each, independently of one another, have one of the meanings indicated above. X⁰ is preferably F, CI, CF₃, OCF₃ or OCHF₂. R⁰ preferably denotes alkyl, alkoxy, oxaalkyl, fluoroalkyl or alkenyl, each having up to 8 C atoms.
LC medium which additionally comprises one or more compounds of the following formula:

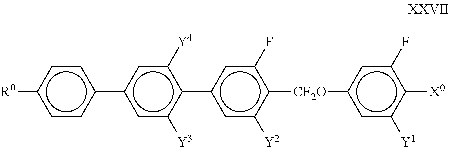

in which R⁰, X⁰ and Y¹⁻⁴ have the meanings indicated above. Particular preference is given to compounds of the following formula:

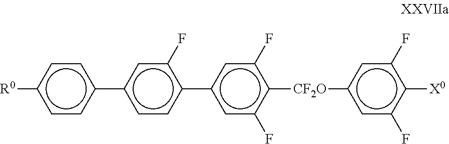

LC medium which additionally comprises one or more compounds of the following formula:

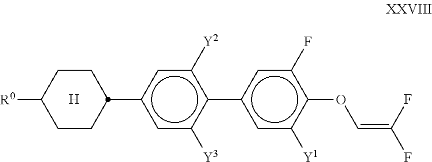

in which R₀ and Y¹⁻³ have the meanings indicated above. Particular preference is given to compounds of the following formulae:

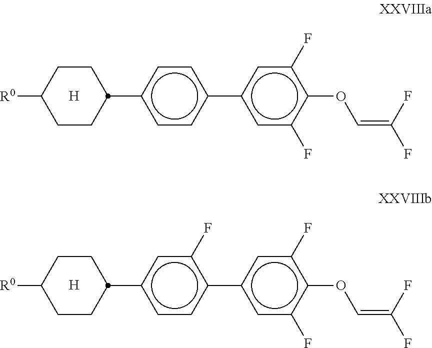

in which R⁰ has the meaning indicated above and preferably denotes alkyl, alkoxy, oxaalkyl, fluoroalkyl or alkenyl, each having up to 8 C atoms.
LC medium which additionally comprises one or more compounds of the following formula:

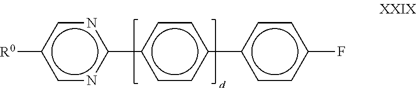

in which R⁰ has the meaning indicated above and is preferably straight-chain alkyl having 2-5 C atoms, and d denotes 0 or 1, preferably 1. Preferred mixtures comprise 3 - 30% by weight, in particular 5 - 20% by weight, of this (these) compound(s).
LC medium which additionally comprises one or more compounds of the following formula:

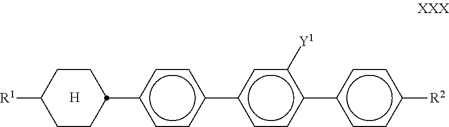

in which Y¹, R¹ and R² have the meanings indicated above. R¹ and R² preferably each, independently of one another, denote alkyl having 1 to 8 C atoms. Y¹ preferably denotes F. Preferred mixtures comprise 1 - 15% by weight, in particular 1 - 10% by weight, of these compounds.

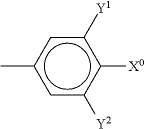

is preferably

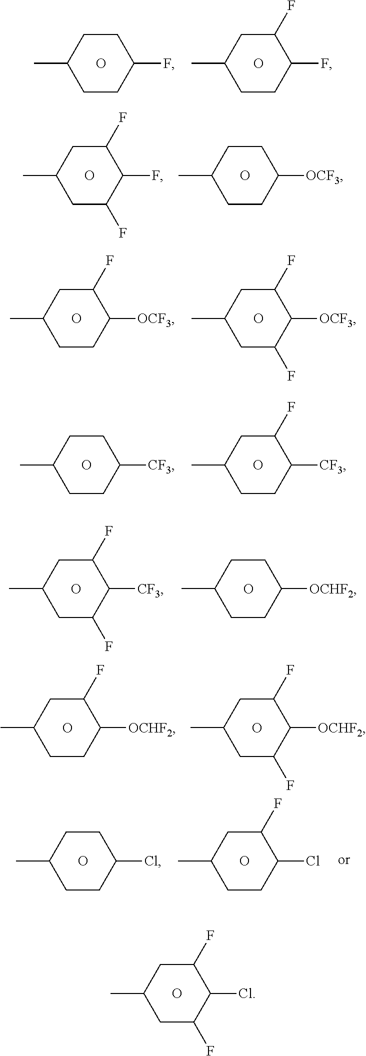

R⁰ is preferably straight-chain alkyl or alkenyl having 2 to 7 C atoms;
X⁰ is preferably F, furthermore OCF₃, CI or CF₃;
the medium preferably comprises one, two or three compounds of the formula I;
the medium preferably comprises a compound of the formula II;
the medium preferably comprises one or more compounds selected from the group of the compounds of the formulae III, IV, VII-2, VIII-1, XII, XIII, XIV, XV, XXV, XXVI, XXVII, XXVIII and XXX;
the medium preferably comprises in each case one or more compounds of the formulae VII-2, XII and XXVII;
the medium preferably comprises 1-25% by weight, preferably 3-20% by weight, of compounds of the formula I;
the medium preferably comprises in total 10 ppm to 10,000 ppm, preferably 50 ppm to 2000 ppm and very particularly preferably 100 to 1000 ppm of compounds of the formula II;
the proportion of compounds of the formulae III-XXX in the mixture as a whole is preferably 75 to 99% by weight;
the medium preferably comprises 25-80% by weight, particularly preferably 30-70% by weight, of compounds of the formulae III and/or IV;
the medium preferably comprises 20-70% by weight, particularly preferably 25-60% by weight, of compounds of the formula IIIa, in particular in which R^{3a} denotes H;
the medium preferably comprises 2-25% by weight, particularly preferably 3-15% by weight, of compounds of the formula VII-2;
the medium comprises 2-25% by weight, particularly preferably 3-15% by weight, of compounds of the formula XII;
the medium preferably comprises 1-20% by weight, particularly preferably 2-15% by weight, of compounds of the formula XXV;
the medium preferably comprises 1-25% by weight, particularly preferably 2-20% by weight, of compounds of the formula XXVII;
the medium preferably comprises 1-35% by weight, particularly preferably 5-30% by weight, of compounds of the formula XXVIII;
the medium preferably comprises one or more compounds selected from the group of the compounds of the formulae VII-2, VIII-1a, VIII-1b, X, XI, XII and XXVII (CF₂O-bridged compounds).

It has been found that even a relatively small proportion of compounds of the formula II mixed with conventional liquid-crystal materials comprising compounds of the formula I, results in a significant increase in the light stability, with broad nematic phases having low smectic-nematic transition temperatures being observed at the same time, improving the storage stability. The mixtures simultaneously exhibit very short response times and very good values for the VHR after exposure to UV and at elevated temperature.

Measurements of the voltage holding ratio (HR) [S. Matsumoto et al., Liquid Crystals 5, 1320 (1989); K. Niwa et al., Proc. SID Conference, San Francisco, June 1984, p. 304 (1984); G. Weber et al., Liquid Crystals 5, 1381 (1989)] have shown that mixtures according to the invention comprising compounds of the formula I exhibit a significantly smaller decrease in the HR on UV exposure than analogous mixtures comprising cyano-phenylcyclohexanes of the formula

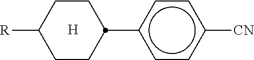

or esters of the formula

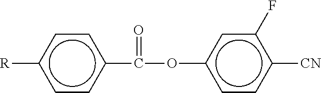

instead of the compounds of the formula I. The LC media are preferably 99% by weight, particularly preferably 100% by weight, free from benzonitrile derivatives.

The light stability and UV stability of the mixtures according to the invention are considerably better, i.e. they exhibit a significantly smaller decrease in the HR on exposure to light or UV than unstabilised mixtures. Even low concentrations of the compounds (≤1% by weight) of the formulae II in the mixtures increase the HR by 10% or more compared with mixtures from the prior art.

The term “alkyl” or “alkyl*” in this application encompasses straight-chain and branched alkyl groups having 1-7 carbon atoms, in particular the straight-chain groups methyl, ethyl, propyl, butyl, pentyl, hexyl and heptyl. Groups having 1-6 carbon atoms are generally preferred.

The term “alkenyl” or “alkenyl*” in this application encompasses straight-chain and branched alkenyl groups having 2-7 carbon atoms, in particular the straight-chain groups. Preferred alkenyl groups are C₂-C₇-1 E-alkenyl, C₄-C₇-3E-alkenyl, C₅-C₇-4-alkenyl, C₆-C₇-5-alkenyl and C₇-6-alkenyl, in particular C₂-C₇-1E-alkenyl, C₄-C₇-3E-alkenyl and C₅-C₇-4-alkenyl. Examples of particularly preferred alkenyl groups are vinyl, 1 E-propenyl, 1E-butenyl, 1 E-pentenyl, 1 E-hexenyl, 1 E-heptenyl, 3-butenyl, 3E-pentenyl, 3E-hexenyl, 3E-heptenyl, 4-pentenyl, 4Z-hexenyl, 4E-hexenyl, 4Z-hept-enyl, 5-hexenyl, 6-heptenyl and the like. Groups having up to 5 carbon atoms are generally preferred.

The term “fluoroalkyl” in this application encompasses straight-chain groups containing at least one fluorine atom, preferably a terminal fluorine, i.e. fluoromethyl, 2-fluoroethyl, 3-fluoropropyl, 4-fluorobutyl, 5-fluoropentyl, 6-fluorohexyl and 7-fluoroheptyl. However, other positions of the fluorine are not excluded.

The term “oxaalkyl” or “alkoxy” in this application encompasses straight-chain radicals of the formula CₙH₂ₙ₋₁—O—(CH₂)ₘ, in which n and m each, independently of one another, denote 1 to 6. m may also denote 0. Preferably, n=1 and m=1-6 or m=0 and n=1-3.

The term “halogenated alkyl radical” preferably encompasses mono- or polyfluorinated and/or -chlorinated radicals. Perhalogenated radicals are included. Particular preference is given to fluorinated alkyl radicals, in particular CF₃, CH₂CF₃, CH₂CHF₂, CHF₂, CH₂F, CHFCF₃ and CF₂CHFCF₃.

If R⁰ in the formulae above and below denotes an alkyl radical and/or an alkoxy radical, this may be straight-chain or branched. It is preferably straight-chain, has 2, 3, 4, 5, 6 or 7 C atoms and accordingly preferably denotes ethyl, propyl, butyl, pentyl, hexyl, heptyl, ethoxy, propoxy, butoxy, pentoxy, hexyloxy or heptyloxy, furthermore methyl, octyl, nonyl, decyl, undecyl, dodecyl, tridecyl, tetradecyl, pentadecyl, methoxy, octoxy, nonoxy, decoxy, undecoxy, dodecoxy, tridecoxy or tetradecoxy.

Oxaalkyl preferably denotes straight-chain 2-oxapropyl (=methoxymethyl), 2- (=ethoxymethyl) or 3-oxabutyl (=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl, 2-, 3-, 4-, 5-, 6-, 7-, 8- or 9-oxadecyl.

If R⁰ denotes an alkyl radical in which a CH₂ group has been replaced by —CH═CH—, this may be straight-chain or branched. It is preferably straight-chain and has 2 to 10 C atoms. Accordingly, it denotes, in particular, vinyl, prop-1- or -2-enyl, but-1-, -2- or -3-enyl, pent-1-, -2-, -3- or -4-enyl, hex-1-, -2-, -3-, -4- or -5-enyl, hept-1-, -2-, -3-, -4-, -5- or -6-enyl, oct-1-, -2-, -3-, -4-, -5-, -6- or -7-enyl, non-1-, -2-, -3-, -4-, -5-, -6-, -7- or -8-enyl, dec-1-, -2-, -3-, -4-, -5-, -6-, -7-, -8- or -9-enyl. These radicals may also be mono- or polyhalogenated.

If R⁰ denotes an alkyl or alkenyl radical which is at least monosubstituted by halogen, this radical is preferably straight-chain, and halogen is preferably F or Cl. In the case of polysubstitution, halogen is preferably F. The resultant radicals also include perfluorinated radicals. In the case of monosubstitution, the fluorine or chlorine substituent may be in any desired position, but is preferably in the ψ-position.

In the formulae above and below, X⁰ is preferably F, CI or a mono- or polyfluorinated alkyl or alkoxy radical having 1, 2 or 3 C atoms or a mono- or polyfluorinated alkenyl radical having 2 or 3 C atoms. X⁰ is particularly preferably F, CI, CF₃, CHF₂, OCF₃, OCHF₂, OCFHCF₃, OCFHCHF₂, OCFHCHF₂, OCF₂CH₃, OCF₂CHF₂, OCF₂CHF₂, OCF₂CF₂CHF₂, OCF₂CF₂CH₂F, OCFHCF₂CF₃, OCFHCF₂CHF₂, OCH═CF₂, OCF═CF₂, OCF₂CHFCF₃, OCF₂CF₂CF₃, OCF₂CF₂CCIF₂, OCCIFCF₂CF₃, CF═CF₂, CF═CHF or CH═CF₂, very particularly preferably F or OCF₃.

The optimum mixing ratio of the compounds of the above-mentioned formulae depends substantially on the desired properties, on the choice of the components of the above-mentioned formulae and on the choice of any further components that may be present.

Suitable mixing ratios within the range indicated above can easily be determined from case to case.

The individual compounds of the above-mentioned formulae and the sub-formulae thereof which can be used in the media according to the invention tion are either known or can be prepared analogously to the known compounds.

The invention also relates to electro-optical displays, such as, for example, TN, VA, TFT, OCB, IPS, FFS or MLC displays, having two plane-parallel outer plates, which, together with a frame, form a cell, integrated non-linear elements for switching individual pixels on the outer plates, and a nematic liquid-crystal mixture, preferably having high specific resistance, located in the cell, which contain media of this type, and to the use of these media for electro-optical purposes.

The liquid-crystal mixtures according to the invention enable a significant broadening of the available parameter latitude. The achievable combinations of clearing point, viscosity at low temperature, thermal and UV stability and high optical anisotropy are far superior to previous materials from the prior art.

The mixtures according to the invention are particularly suitable for mobile applications and high-Δn TFT applications, such as, for example, PDAs, notebooks, LCD TVs and monitors.

The liquid-crystal mixtures according to the invention, with retention of the nematic phase down to −20° C. and preferably down to −30° C., particularly preferably down to −40° C., and of the clearing point ≥70° C., preferably ≥75° C., simultaneously enable rotational viscosities γ₁ of 100 mPa·s, particularly preferably ≤70 mPa·s, to be achieved, enabling excellent MLC displays having fast response times to be obtained.

The dielectric anisotropy Δε of the liquid-crystal mixtures according to the invention is preferably ≥5, particularly preferably ≥9. In addition, the mixtures are characterised by low operating voltages. The threshold voltage of the liquid-crystal mixtures according to the invention is preferably ≤1.7 V, in particular ≤1.6 V.

The birefringence Δn of the liquid-crystal mixtures according to the invention is preferably ≥0.09, particularly preferably ≥0.10.

The nematic phase range of the liquid-crystal mixtures according to the invention preferably has a width of at least 90° , in particular at least 100° . This range preferably extends at least from −25° C. to +70° C.

It goes without saying that, through a suitable choice of the components of the mixtures according to the invention, it is also possible for higher clearing points (for example above 100° C.) to be achieved at higher threshold voltages or lower clearing points to be achieved at lower threshold voltages with retention of the other advantageous properties. At viscosities correspondingly increased only slightly, it is likewise possible to obtain mixtures having higher Δε and thus low thresholds.

The LC media may also comprise further additives known to the person skilled in the art and described in the literature, such as, for example, UV stabilisers, such as Tinuvin® from Ciba, antioxidants, free-radical scavengers, nanoparticles, etc. For example, 0-15% of pleochroic dyes or chiral dopants can be added. Suitable stabilisers and dopants are mentioned below in Tables C and D.

The individual components of the above-mentioned preferred embodiments of the LC media according to the invention are either known or their preparation methods can readily be derived from the prior art by the person skilled in the relevant art since they are based on standard methods described in the literature.

It goes without saying to the person skilled in the art that the LC media according to the invention may also comprise compounds in which, for example, H, N, O, CI, F have been replaced by the corresponding isotopes.

The liquid-crystal mixtures which can be used in accordance with the invention are prepared in a manner conventional per se, for example by mixing one or more compounds of the formulae I and II with one or more compounds of the formulae III-XXX or with further liquid-crystalline compounds and/or additives. The mixing is preferably carried out under inert gas, for example under nitrogen or argon. In general, the desired amount of the components used in lesser amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing. The invention furthermore relates to the process for the preparation of the LC media according to the invention.

The construction of the MLC display according to the invention from polarisers, electrode base plates and surface-treated electrodes corresponds to the usual design for displays of this type. The term usual design is broadly drawn here and also encompasses all derivatives and modifications of the MLC display, in particular including matrix display elements based on poly-Si TFTs or MIM.

A significant difference between the displays according to the invention and the hitherto conventional displays based on the twisted nematic cell consists, however, in the choice of the liquid-crystal parameters of the liquid-crystal layer.

The following examples explain the present invention without limiting it. However, they show the person skilled in the art preferred mixture concepts with compounds preferably to be employed and the respective concentrations thereof and combinations thereof with one another. In addition, the examples illustrate which properties and property combinations are accessible.

In the present application and in the examples below, the structures of the liquid-crystal compounds are indicated by means of acronyms, with the transformation into chemical formulae taking place in accordance with Tables A and B below. All radicals CₙH₂ₙ₊₁ and CₘH₂ₘ₊₁ are straight-chain alkyl radicals having n and m C atoms respectively; n, m and k are integers and preferably denote 0, 1, 2, 3, 4, 5, 6, 7, 8, 9, 10, 11 or 12. The coding in Table B is self-evident. In Table A, only the acronym for the parent structure is indicated. In individual cases, the acronym for the parent structure is followed, separated by a dash, by a code for the substituents R^{1*}, R^{2*}, L^{1*} and L^{2*}:

| Code for R¹*, | | | | |
|---|---|---|---|---|
| R²*, L¹*, L²*, L³* | R¹* | R²* | L¹* | L²* |
| nm | CₙH₂ₙ₊₁ | CₘH₂ₘ₊₁ | H | H |
| nOm | CₙH₂ₙ₊₁ | OCₘH₂ₘ₊₁ | H | H |
| nO•m | OCₙH₂ₙ₊₁ | CₘH₂ₘ₊₁ | H | H |
| n | CₙH₂ₙ₊₁ | CN | H | H |
| nN•F | CₙH₂ₙ₊₁ | CN | F | H |
| nN•F•F | CₙH₂ₙ₊₁ | CN | F | F |
| nF | CₙH₂ₙ₊₁ | F | H | H |
| nCl | CₙH₂ₙ₊₁ | Cl | H | H |
| nOF | OCₙH₂ₙ₊₁ | F | H | H |
| nF•F | CₙH₂ₙ₊₁ | F | F | H |
| nF•F•F | CₙH₂ₙ₊₁ | F | F | F |
| nOCF₃ | CₙH₂ₙ₊₁ | OCF₃ | H | H |
| nOCF₃•F | CₙH₂ₙ₊₁ | OCF₃ | F | H |
| n-Vm | CₙH₂ₙ₊₁ | —CH═CH—CₘH₂ₘ₊₁ | H | H |
| nV-Vm | CₙH₂ₙ₊₁—CH═CH— | —CH═CH—CₘH₂ₘ₊₁ | H | H |

Preferred mixture components are shown in Tables A and B.

TABLE A

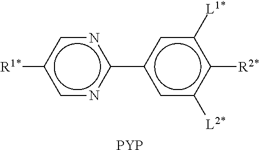

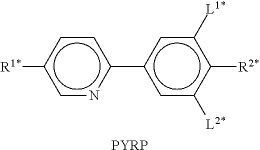

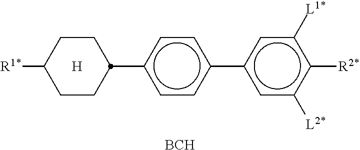

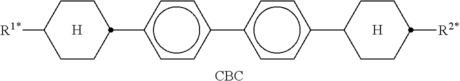

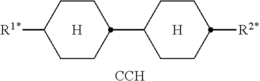

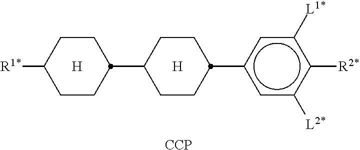

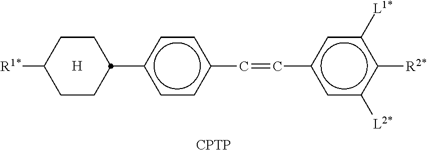

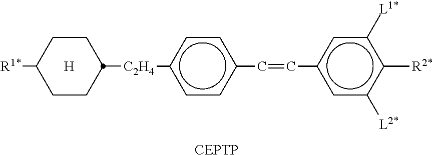

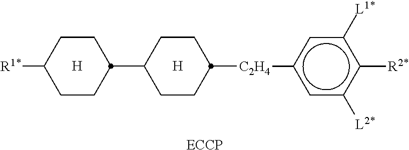

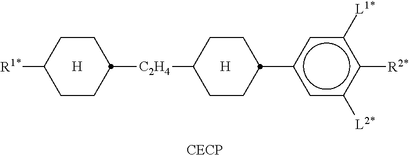

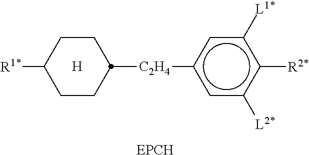

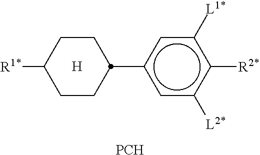

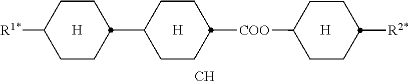

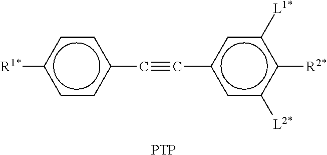

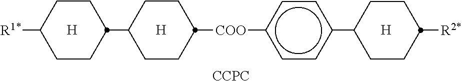

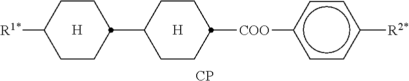

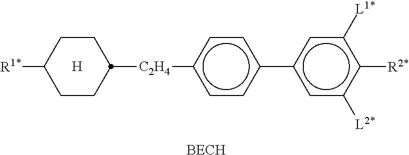

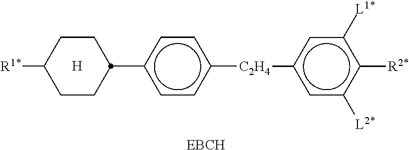

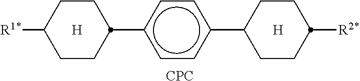

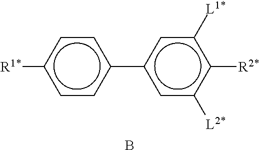

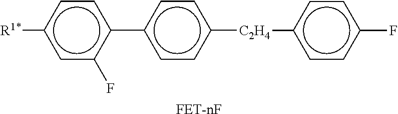

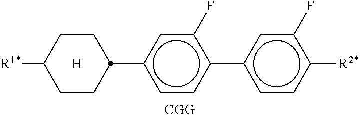

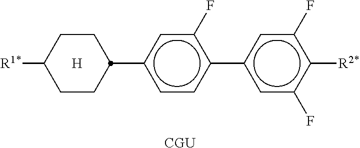

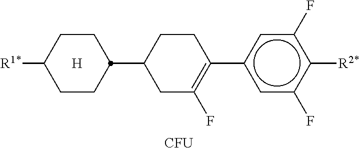

TABLE B

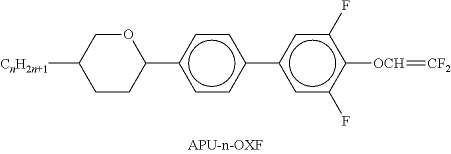

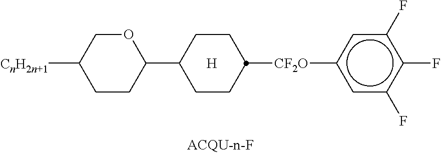

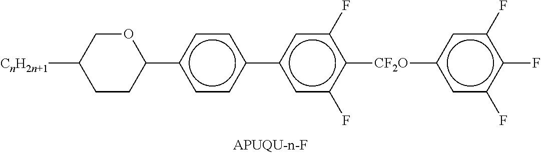

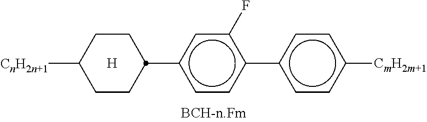

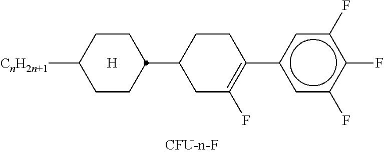

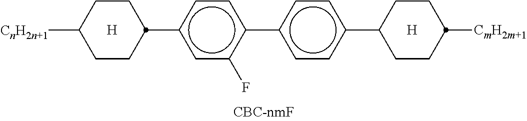

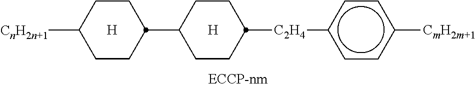

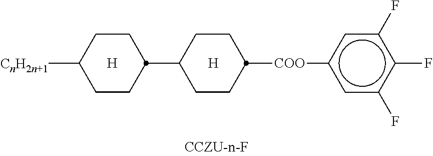

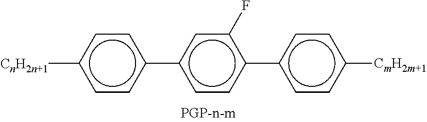

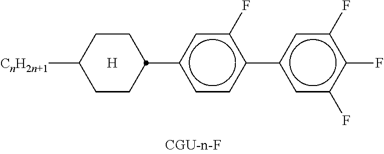

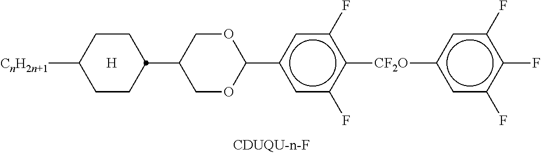

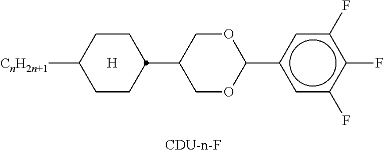

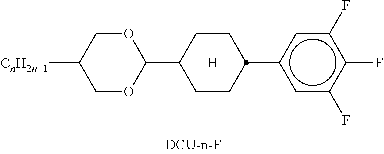

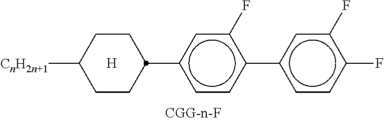

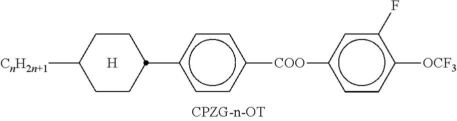

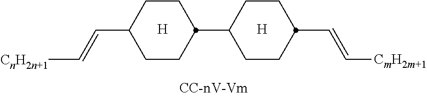

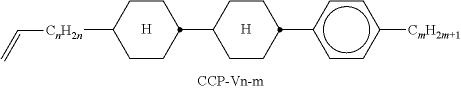

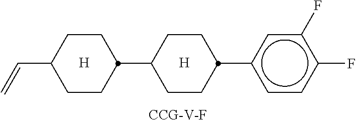

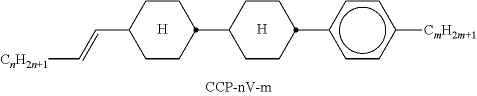

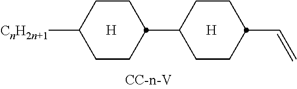

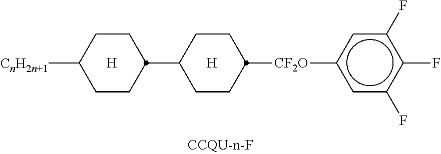

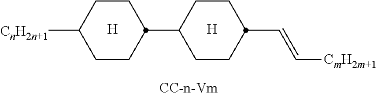

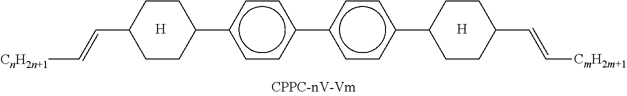

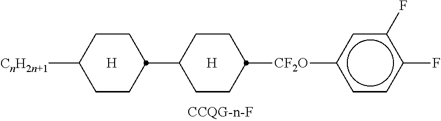

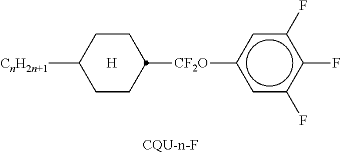

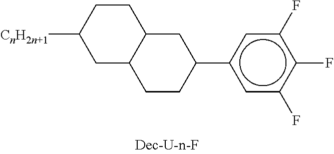

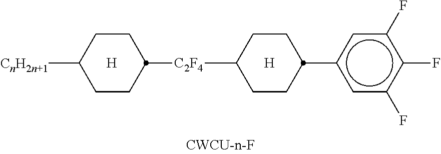

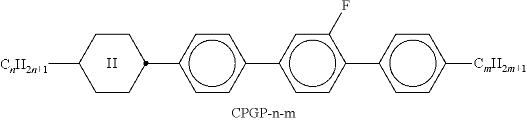

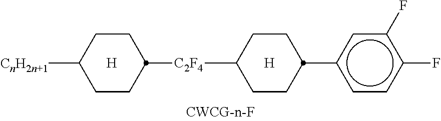

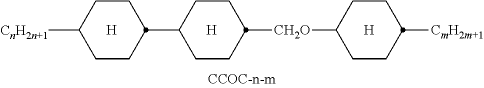

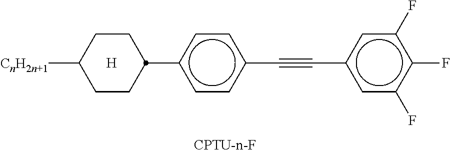

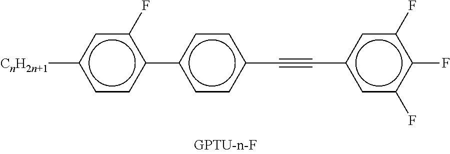

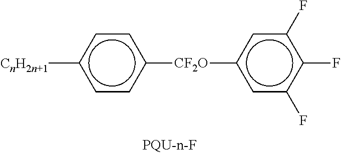

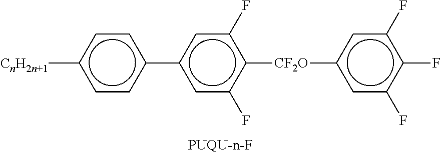

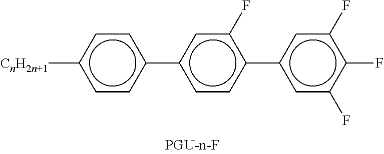

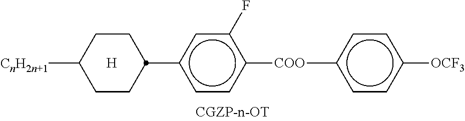

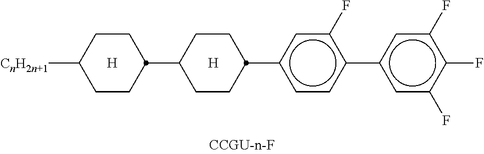

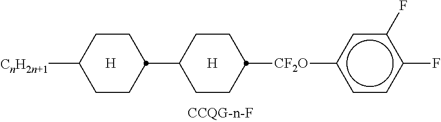

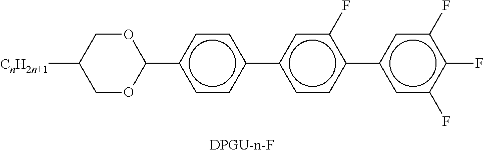

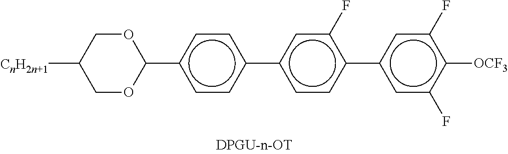

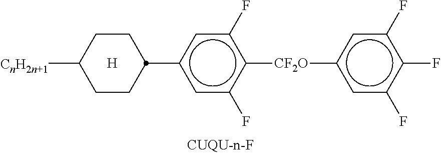

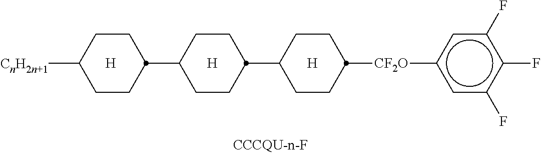

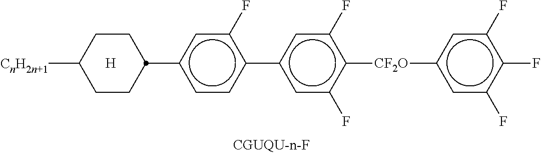

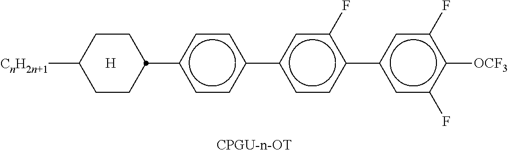

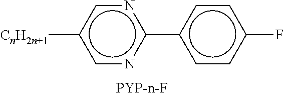

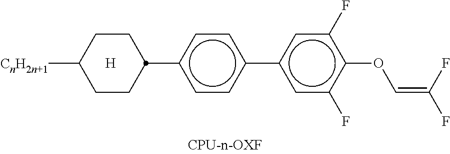

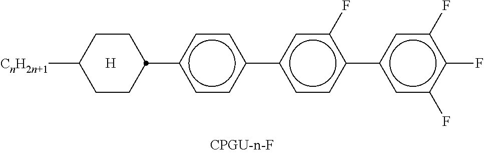

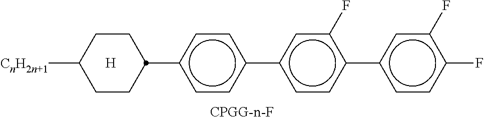

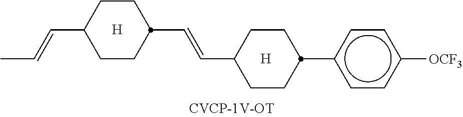

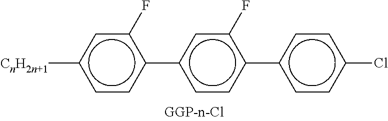

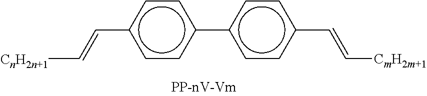

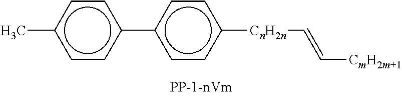

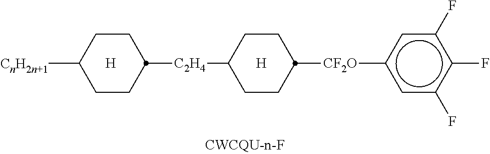

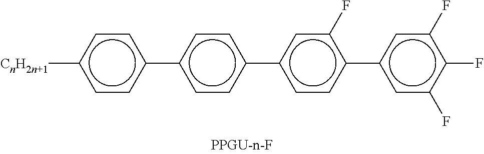

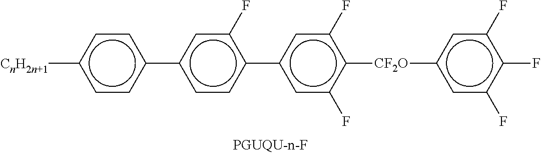

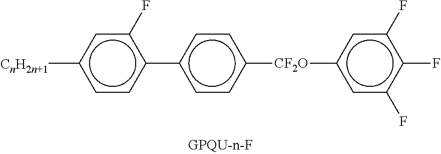

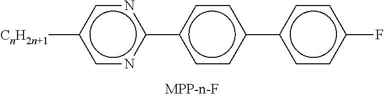

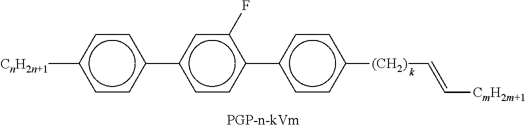

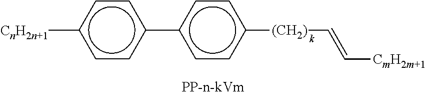

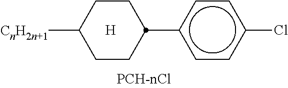

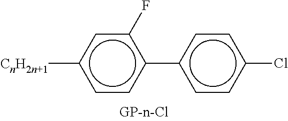

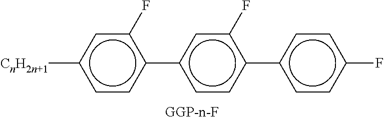

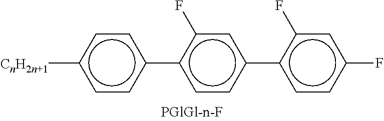

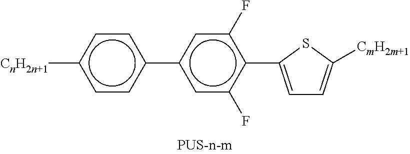

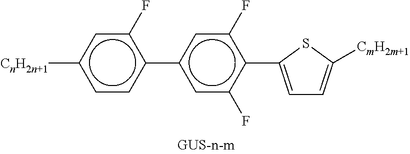

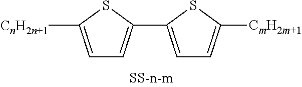

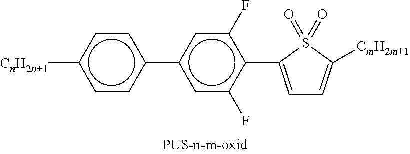

In a preferred embodiment of the present invention, the LC media according to the invention comprise one or more compounds selected from the group consisting of compounds from Tables A and B.

Table C indicates possible dopants which can be added to the LC media according to the invention.

TABLE C

| | |
|---|---|
| 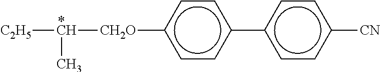 | C 15 |
| 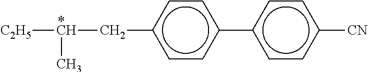 | CB 15 |
| 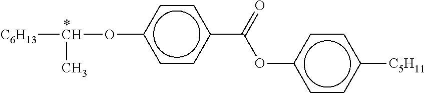 | CM 21 |
| 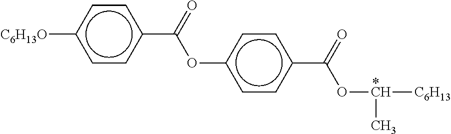 | R/S-811 |
| 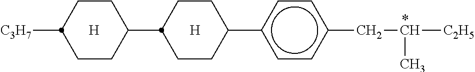 | CM 44 |
| 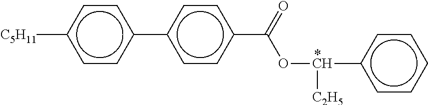 | CM 45 |
| 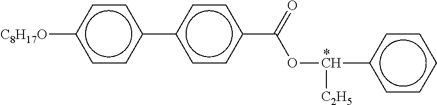 | CM 47 |
| 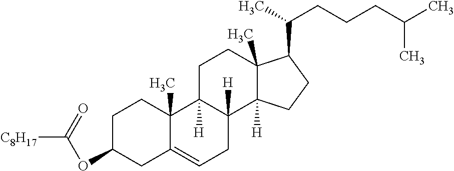 | CN |
| 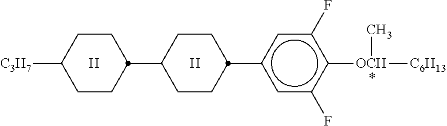 | R/S-2011 |
| 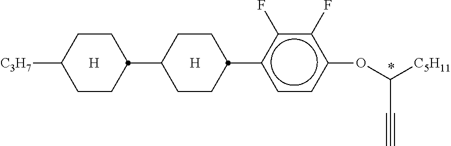 | R/S-3011 |
| 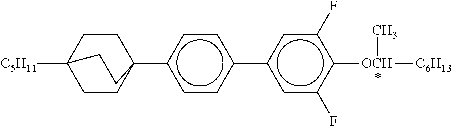 | R/S-4011 |
| 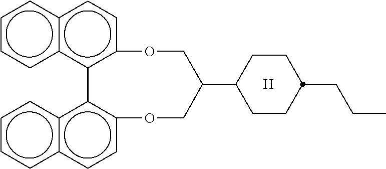 | R/S-5011 |
| 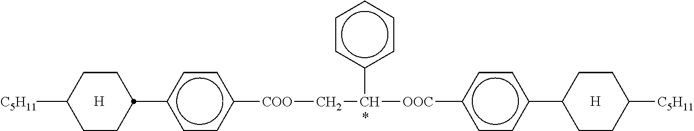 | R/S-1011 |

The LC media preferably comprise 0 to 10% by weight, in particular 0.01 to 5% by weight and particularly preferably 0.1 to 3% by weight, of dopants. The LC media preferably comprise one or more dopants selected from the group consisting of compounds from Table C.

Table D indicates further possible stabilisers which can be added to the LC media according to the invention besides the compounds of the formula II. (n here denotes an integer from 1 to 12)

TABLE D

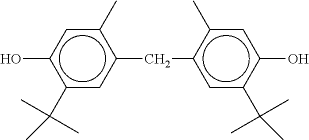

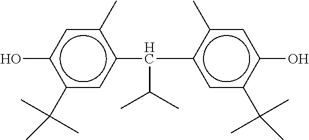

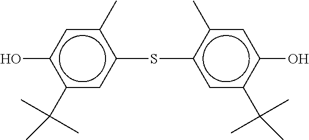

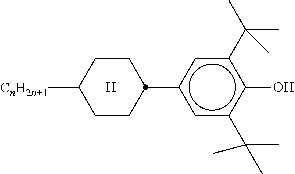

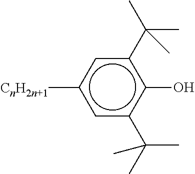

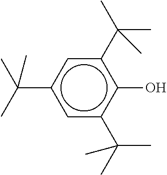

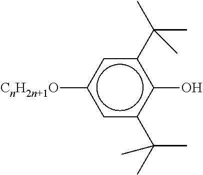

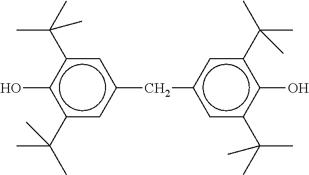

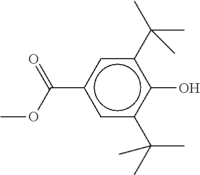

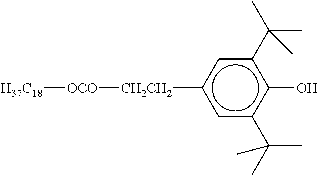

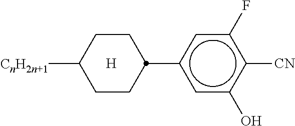

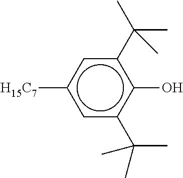

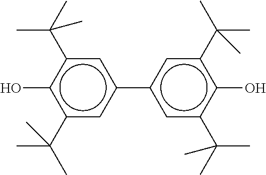

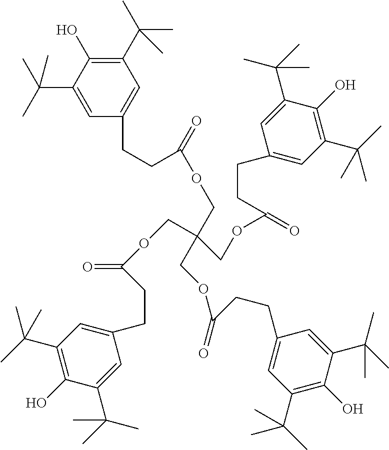 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

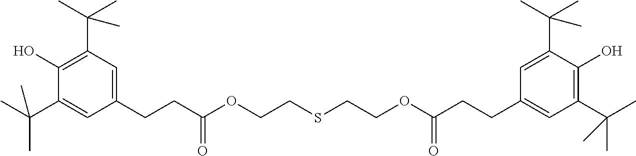 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

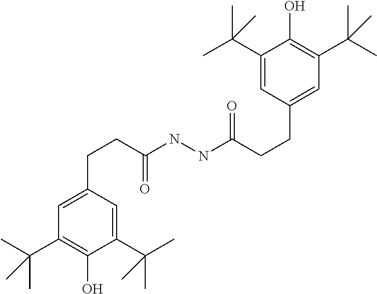 [SMILES: CC(C)(C)c1cc(CCC(=O)NNC(=O)CCc2cc(C(C)(C)C)c(O)c(C(C)(C)C)c2)cc(C(C)(C)C)c1O]

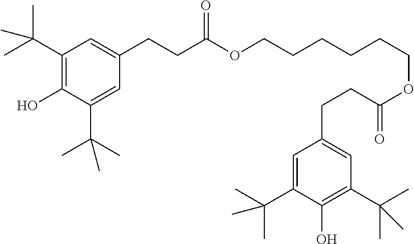 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

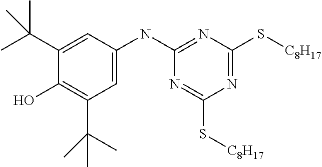

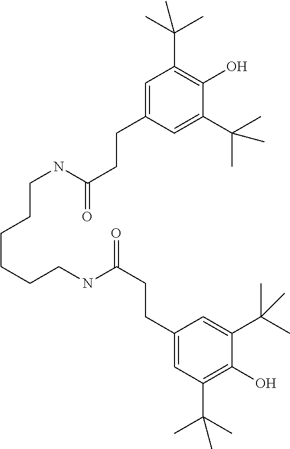 [SMILES: CC(C)(C)c1cc(CCC(=O)NCCCCCCNC(=O)CCc2cc(C(C)(C)C)c(O)c(C(C)(C)C)c2)cc(C(C)(C)C)c1O]

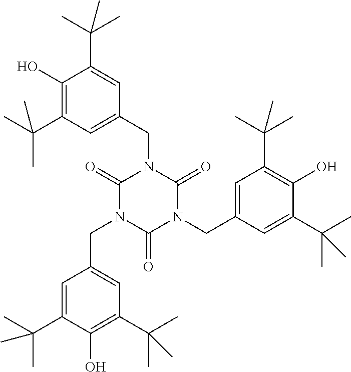 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

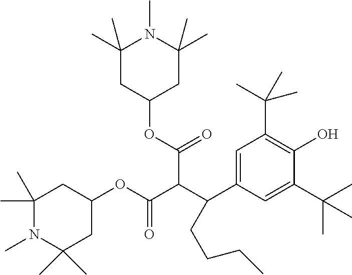 [SMILES: CCCCC(c1cc(C(C)(C)C)c(O)c(C(C)(C)C)c1)C(C(=O)OC1CC(C)(C)N(C)C(C)(C)C1)C(=O)OC1CC(C)(C)N(C)C(C)(C)C1]

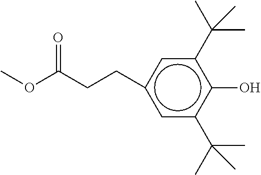

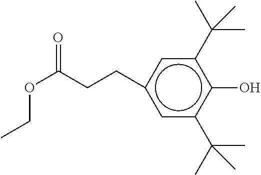

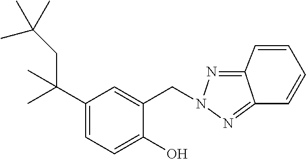 [SMILES: CC(C)(C)CC(C)(C)c1ccc(O)c(Cn2nc3ccccc3n2)c1]

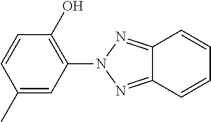 [SMILES: Cc1ccc(O)c(-n2nc3ccccc3n2)c1]

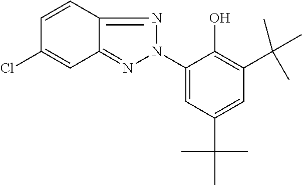 [SMILES: CC(C)(C)c1cc(-n2nc3ccc(Cl)cc3n2)c(O)c(C(C)(C)C)c1]

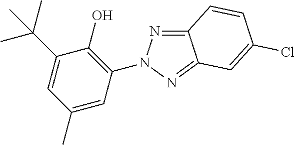 [SMILES: Cc1cc(-n2nc3ccc(Cl)cc3n2)c(O)c(C(C)(C)C)c1]

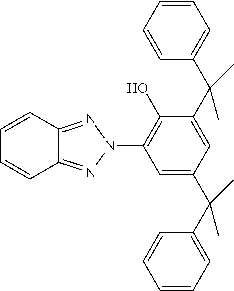 [SMILES: CC(C)(c1ccccc1)c1cc(-n2nc3ccccc3n2)c(O)c(C(C)(C)c2ccccc2)c1]

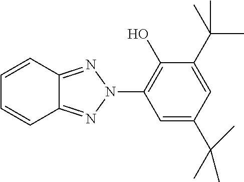 [SMILES: CC(C)(C)c1cc(-n2nc3ccccc3n2)c(O)c(C(C)(C)C)c1]

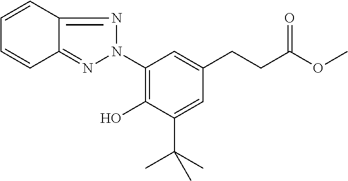 [SMILES: COC(=O)CCc1cc(-n2nc3ccccc3n2)c(O)c(C(C)(C)C)c1]

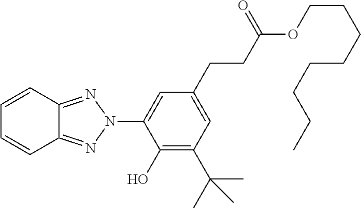 [SMILES: CCCCCCCCOC(=O)CCc1cc(-n2nc3ccccc3n2)c(O)c(C(C)(C)C)c1]

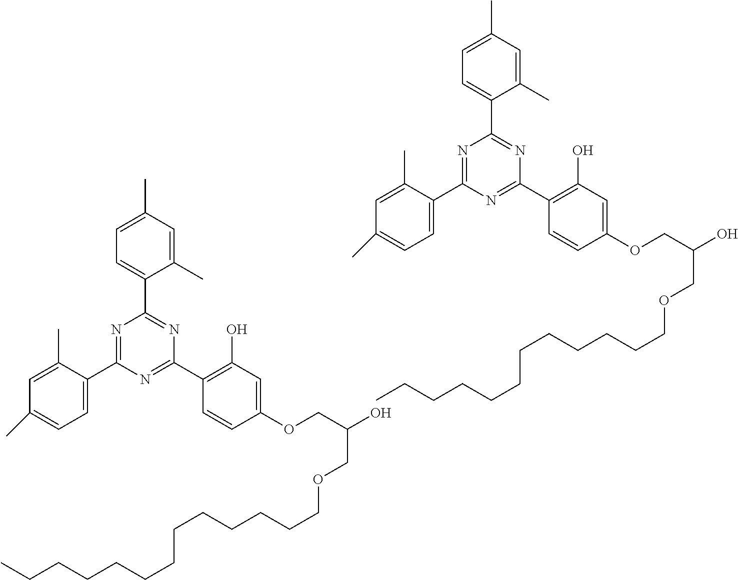

The LC media preferably comprise 0 to 10% by weight, in particular 0.01 to 5% by weight and particularly preferably 0.1 to 3% by weight, of stabilisers. The LC media preferably comprise one or more stabilisers selected from the group consisting of compounds from Table D.

In addition, the following abbreviations and symbols are used:

V₀ threshold voltage, capacitive [V] at 20° C.,

V₁₀ optical threshold for 10% relative contrast [V] at 20° C.,

nₑ extraordinary refractive index at 20° C. and 589 nm,

nₒ ordinary refractive index at 20° C. and 589 nm,

Δn optical anisotropy at 20° C. and 589 nm,

ε₁₉₅ dielectric susceptibility perpendicular to the director at 20° C. and 1 kHz,

ε_{|} dielectric susceptibility parallel to the director at 20° C. and 1 kHz,

Δε dielectric anisotropy at 20° C. and 1 kHz,

cl.p., T(N,I) clearing point [° C.],

γ₁ rotational viscosity at 20° C. [mPa·s],

K₁ elastic constant, “splay” deformation at 20° C. [pN],

K₂ elastic constant, “twist” deformation at 20° C. [pN],

K₃ elastic constant, “bend” deformation at 20° C. [pN],

LTS low-temperature stability (phase), determined in test cells,

tₒₙ switch-on time [change in transmission from 10% to 90%] at 20 ° C. and defined operating voltage,

t_{off} switch-off time [change in transmission from 90% to 10%] at 20 ° C.,

RT reaction time (tₒₙ+t_{off})

HR₂₀ voltage holding ratio at 20° C. [%] and

HR₁₀₀ voltage holding ratio at 100° C. [%].

Unless explicitly noted otherwise, all concentrations in the present application are indicated in per cent by weight and relate to the corresponding mixture as a whole without solvents.

Unless explicitly noted otherwise, all temperature values indicated in the present application, such as, for example, the melting point T(C,N), the transition from the smectic (S) to the nematic (N) phase T(S,N) and the clearing point T(N,I), are indicated in degrees Celsius (° C.). M.p. denotes melting point, cl.p.=clearing point. Furthermore, C=crystalline state, N=nematic phase, S=smectic phase and I=isotropic phase. The data between these symbols represent the transition temperatures.

All physical properties are and have been determined in accordance with “Merck Liquid Crystals, Physical Properties of Liquid Crystals”, Status November 1997, Merck KGaA, Darmstadt, Germany, and apply to a temperature of 20° C., and Δn is determined at 589 nm and Δε at 1 kHz, unless explicitly indicated otherwise in each case.

The liquid-crystalline properties of the individual compounds are, unless indicated otherwise, determined in the nematic host mixture ZLI-4792 (commercially available from Merck KGaA, Darmstadt) at a concentration of 10%.

“Room temperature” means 20° C., unless indicated otherwise.

The term “threshold voltage” for the present invention relates to the capacitive threshold (V₀), also called the Freedericks threshold, unless explicitly indicated otherwise. In the examples, as generally usual, the optical threshold for 10% relative contrast (V₁₀) may also be indicated.

The test cells used for measurement of the capacitive threshold voltage V₀ and for V₁₀ are constructed from substrates consisting of soda-lime glass coated with polyimide alignment layers (Durimid® 32 with diluent (70% of NMP +30% of xylene) in the ratio 1:4) from Arch Chemicals, which are rubbed antiparallel to one another and have a surface tilt of quasi 0 degrees. The area of the transparent, virtually square ITO electrodes is 1 cm². The capacitive threshold voltage is determined using a standard commercial high-resolution LCR meter (for example Hewlett Packard 4284A LCR meter).

### EXAMPLES

### Thiophene-Containing Base Mixture M1

A nematic LC mixture is formulated as follows:

| | | | | |
|---|---|---|---|---|
| APUQU-2-F | 12.0% | Cl.p. | +80° | C. |
| APUQU-3-F | 12.0% | γ₁ | 71 | mPa s |

| | | | |
|---|---|---|---|
| CC-3-V | 36.0% | Δn | 0.111 |
| CC-3-V1 | 4.0% | Δϵ | +10.6 |
| CCP-V-1 | 12.0% | HR₁₀₀ (1 h UV) | 44% |
| CCQU-3-F | 6.0% | | |
| PUQU-3-F | 9.0% | | |
| PUS-3-2 | 9.0% | | |

### Mixture Example 1 (Mixture M1 Stabilised with Tinuvin® 770)

A nematic LC mixture according to the invention is formulated as follows:

| | | | |
|---|---|---|---|
| Mixture M1 | 99.999% | HR₁₀₀ (1 h UV) | 64% |
| Tinuvin ® 770 | 100 ppm | | |

Addition of 100 ppm of Tinuvin® 770 significantly improves the HR₁₀₀ after UV exposure compared with the unstabilised mixture Ml.

### Mixture Example 2 (Mixture M1 Stabilised with Tinuvin® 770)

A nematic LC mixture according to the invention is formulated as follows:

| | | | |
|---|---|---|---|
| Mixture M1 | 99.99% | HR₁₀₀ (1 h UV) | 83% |
| Tinuvin ® 770 | 1000 ppm | | |

Addition of 1000 ppm of Tinuvin® 770 significantly improves the HR₁₀₀ after UV exposure compared with Mixture Example 1 comprising 100 ppm of stabiliser and very considerably compared with the unstabilised mixture M1.

### Mixture Example 3 (Mixture M1 Stabilised with Tinuvin® 770 and Tinuvin® P)

A nematic LC mixture according to the invention is formulated as follows:

| | | | |
|---|---|---|---|
| Mixture M1 | 99.699% | HR₁₀₀ (1 h UV) | 74% |
| Tinuvin ® P | 0.30% | | |
| Tinuvin ® 770 | 100 ppm | | |

The HR₁₀₀ can be improved further compared with Mixture Example 1 by additional use of Tinuvin® P, but this combination is, in spite of the significantly higher concentration of stabiliser overall, less effective than on use of 1000 ppm of Tinuvin® 770 alone (Mixture Example 2).

### Thiophene-Containing Base Mixture M2

A nematic LC mixture is formulated as follows:

| | | | | |
|---|---|---|---|---|
| PUQU-3-F | 5.0% | Cl.p. | +74.5° | C. |
| PGUQU-3-F | 7.0% | γ₁ | 55 | mPa · s |

| | | | |
|---|---|---|---|
| APUQU-2-F | 8.0% | Δn | 0.1026 |
| APUQU-3-F | 8.0% | Δϵ | +7.6 |
| CC-3-V | 47.0% | HR₁₀₀ (1 h UV) | 51% |
| CC-3-V1 | 7.0% | | |
| CCP-V-1 | 11.0% | | |
| PUS-2-2 | 7.0% | | |

### Mixture Example 4 (Mixture M2 Stabilised with Tinuvin® 770)

A nematic LC mixture according to the invention is formulated as follows:

| | | | |
|---|---|---|---|
| Mixture M2 | 99.99% | HR₁₀₀ (1 h UV) | 79% |
| Tinuvin ® 770 | 1000 ppm | | |

### Thiophene-Containing Base Mixture M3

A nematic LC mixture is formulated as follows:

| | | | | |
|---|---|---|---|---|
| PUQU-3-F | 9.0% | Cl.p. | +74.0° | C. |
| CPGU-3-OT | 9.0% | γ₁ | 61 | mPa s |

| | | | |
|---|---|---|---|
| PUQU-2-F | 14.0% | Δn | 0.132 |
| CC-3-V | 43.5% | Δϵ | +7.9 |
| CCP-V-1 | 4.5% | HR₁₀₀ (1 h UV) | 48% |
| PP-1-2V1 | 3.0% | | |
| PGP-2-2V | 11.0% | | |
| PUS-3-2 | 6.0% | | |

### Mixture Example 5 (Mixture M3 Stabilised with Tinuvin® 770) A nematic LC mixture according to the invention is formulated as follows:

| | | | |
|---|---|---|---|
| Mixture M3 | 99.99% | HR₁₀₀ (1 h UV) | 81% |
| Tinuvin ® 770 | 1000 ppm | | |

### Thiophene-Containing Base Mixture M4

A nematic LC mixture is formulated as follows:

| | | | | |
|---|---|---|---|---|
| PUQU-3-F | 8.0% | Cl.p. | +74.0° | C. |
| CPGU-3-OT | 5.5% | γ₁ | 58 | mPa · s |

| | | | |
|---|---|---|---|
| PUQU-2-F | 15.0% | Δn | 0.132 |
| CC-3-V | 44.0% | Δϵ | +7.2 |
| CCP-V-1 | 7.0% | HR₁₀₀ (1 h UV) | 55% |
| PGP-2-2V | 3.0% | | |
| CPGP-4-3 | 1.5% | | |
| PUS-3-2 | 16.0% | | |

### Mixture Example 6 (Mixture M4 Stabilised with Tinuvin® 770)

A nematic LC mixture according to the invention is formulated as follows:

| | | | |
|---|---|---|---|
| Mixture M4 | 99.99% | HR₁₀₀ (1 h UV) | 79% |
| Tinuvin ® 770 | 1000 ppm | | |

Mixture Examples 4 to 6 show a significant Improvement in the HR₁₀₀ compared with the unstabilised base mixtures.

1. LC medium, characterised in that it comprises one or more compounds of the formula I, 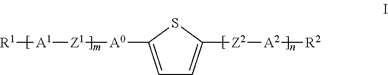
in which the individual radicals have the following meanings:
R¹ and R² denote H, F, Cl, Br, —CN, —SCN, —NCS, SF₅ or straight-chain or branched alkyl having 1 to 12 C atoms, in which, in addition, one or more non-adjacent CH₂ groups may each be replaced, independently of one another, by—CH═CH—, —C≡C—, —O—, —CO—, —CO—O—, —O—CO—, —O—CO—O— in such a way that O atoms are not linked directly to one another, and in which, in addition, one or more H atoms may be replaced by F, Cl or Br,
A⁰, A¹ and A² each, independently of one another, denote phenylene-1,4-diyl, in which, in addition, one or two CH groups may be replaced by N and one or more H atoms may be replaced by halogen, CN, CH₃, CHF₂, CH₂F, CF₃, OCH₃, OCHF₂ or OCF₃, cyclohexane-1,4-diyl, in which, in addition, one or two non-adjacent CH₂ groups may be replaced, independently of one another, by O and/or S and one or more H atoms may be replaced by F, cyclohexene-1,4-diyl, bicyclo-[1.1.1]pentane-1,3-diyl, bicyclo[2.2.2]octane-1,4-diyl, spiro[3.3]-heptane-2,6-diyl, tetrahydropyran-2,5-diyl or 1,3-dioxane-2,5-diyl,
Z¹ and Z² each, independently of one another, denote —CF₂O—, —OCF₂—, —CH₂O—, —OCH₂—, —CO—O—, —O—CO—, —C₂H₄—, —C₂F₄—, —CF₂CH₂—, —CH₂CF₂—, —CFHCFH—, —CFHCH₂—, —CH₂CFH—, —CF₂CFH—, —CFHCF₂—, —CH═CH—, —CF═CH—, —CH═CF—, —CF═CF—, —C≡C— or a single bond, m and n each, independently of one another, denote 0, 1, 2 or 3,
and
one or more compounds selected from the group of the compounds of the formula II, 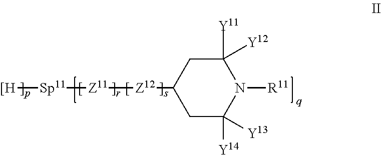
in which
q denotes 1 or 2,
p denotes (2-q),
Z¹¹ and Z¹², independently of one another, denote —O—, —(C═O)— or a single bond, but do not both simultaneously denote —O—,
r and s, independently of one another, denote 0 or 1,
Y¹¹ to Y¹⁴ each, independently of one another, denote alkyl having 1 to 4 C atoms and alternatively also, independently of one another, one or both of the pairs (Y¹¹ and Y¹²) and (Y¹³ and Y¹⁴) together denote a divalent group having 3 to 6 C atoms,
R¹¹ on each occurrence, independently of one another, denotes H, alkyl, O-alkyl, O-cycloalkyl, O^{⋅} or OH,
Sp¹¹ denotes a straight-chain or branched alkyl chain having 2-20 C atoms, in which one or more —CH₂— groups may be replaced by —O—, but two adjacent —CH₂— groups cannot be replaced by —O—, or denotes a hydrocarbon radical which contains a cycloalkyl or alkylcycloalkyl unit and in which one or more —CH₂— groups may be replaced by —O—, but two adjacent —CH₂— groups cannot be replaced by —O—.

2. LC medium according to claim 1, characterised in that it comprises one or more compounds of the formula I selected from the group of the compounds I1 to I16, 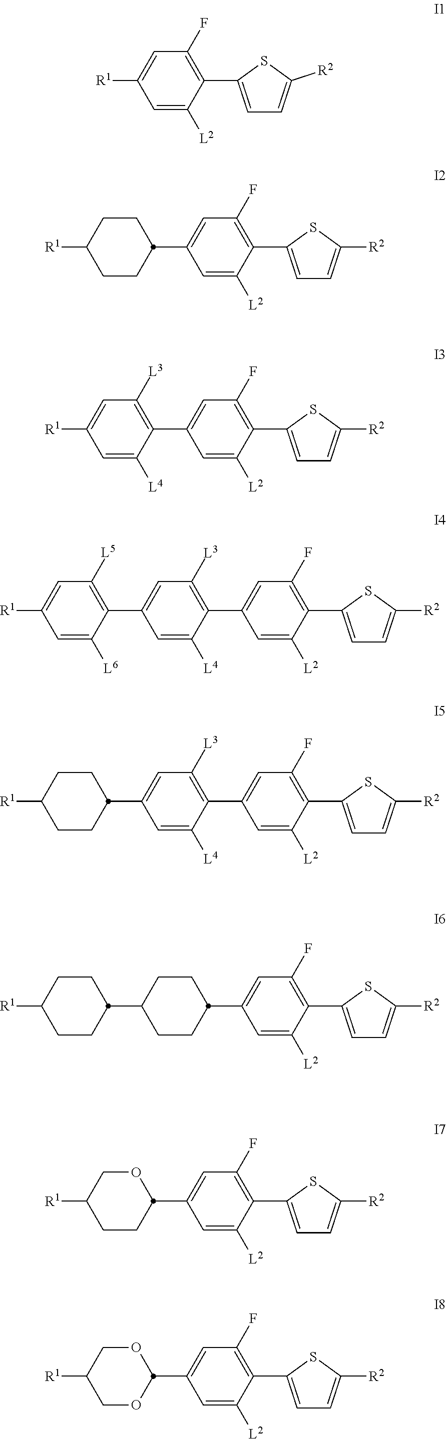 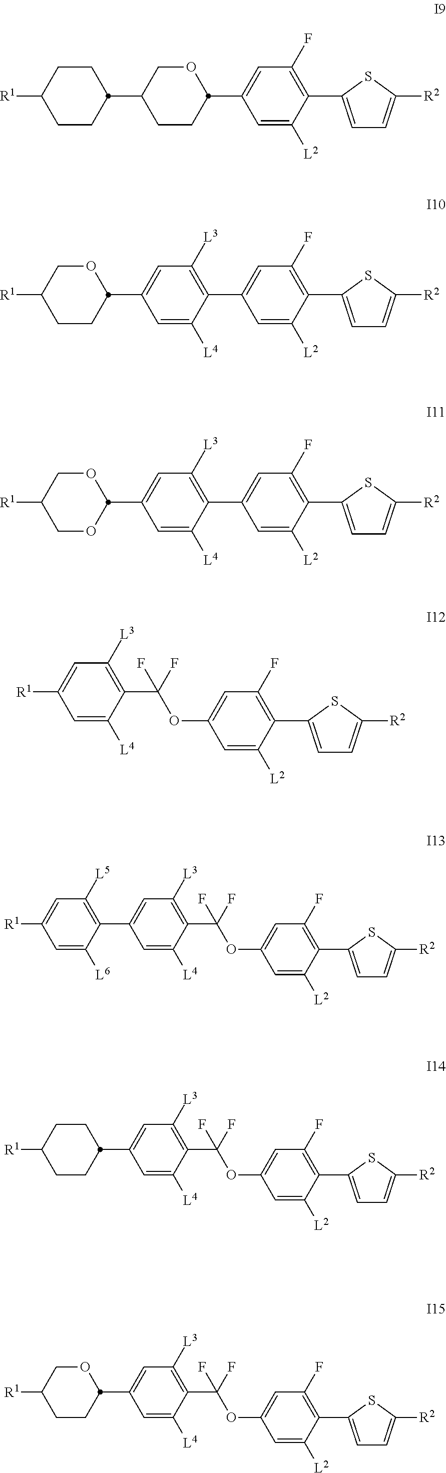 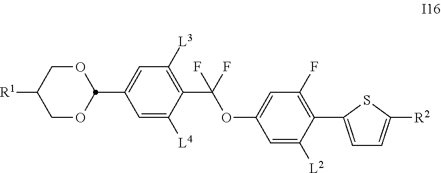
in which R¹, R² and L¹ to L⁶ have the meanings indicated in claim 1.

3. LC medium according to claim 1, characterised in that, in formula I, m denotes 1, n denotes 0 and A⁰ denotes

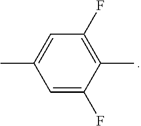

4. LC medium according to claim 1, characterised in that it additionally comprises one or more compounds of the formula III and/or IV: 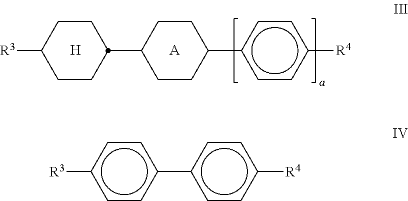
in which
A denotes 1,4-phenylene or trans-1,4-cyclohexylene,
a is 0 or 1,
R³ denotes alkyl or alkenyl having up to 9 C atoms, and
R⁴ denotes alkyl having 1 to 12 C atoms, where, in addition, one or two non-adjacent CH₂ groups may be replaced by —O—, —CH═CH—, —CO—, —OCO— or —COO— in such a way that O atoms are not linked directly to one another.

5. LC medium according to claim 1, characterised in that it additionally comprises one or more compounds selected from the group consisting of the following formulae: 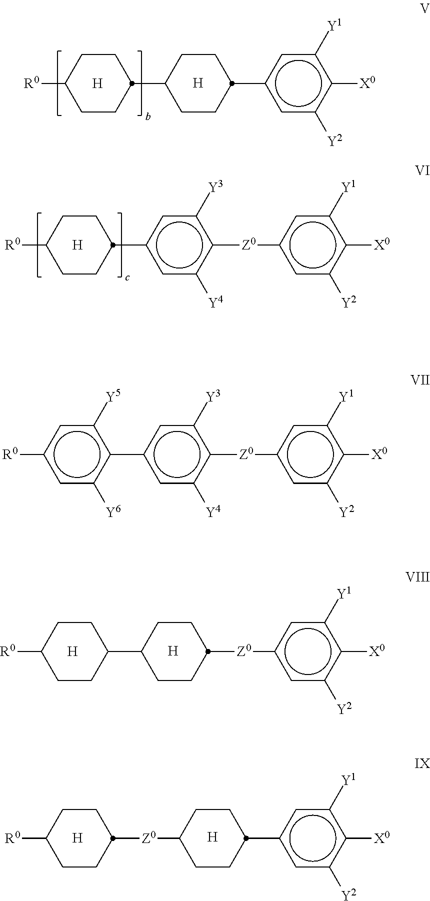
in which
R⁰ denotes an alkyl or alkoxy radical having 1 to 15 C atoms, where, in addition, one or more CH₂ groups in these radicals may each be replaced, independently of one another, by —C≡C—, —CF₂O—, —CH═CH—, 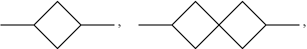
—O—, —CO—O— or —O—CO— in such a way that O atoms are not linked directly to one another, and in which, in addition, one or more H atoms may be replaced by halogen,
X⁰ denotes F, Cl, CN, SF₅, SCN, NCS, a halogenated alkyl radical, halogenated alkenyl radical, halogenated alkoxy radical or halogenated alkenyloxy radical, each having up to 6 C atoms,
Y¹⁻⁶ each, independently of one another, denote H or F,
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO—, —CF₂O— or —OCF₂—, in the formulae V and VI also a single bond, and
b and c each, independently of one another, denote 0 or 1.

6. LC medium according to claim 1, characterised in that it additionally comprises one or more compounds selected from the group consisting of the following formulae: 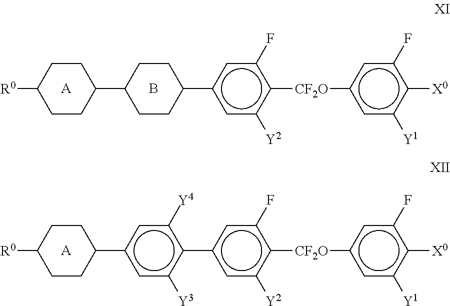
in which R⁰ , X⁰ and Y¹⁻⁴ have the meanings indicated above, and 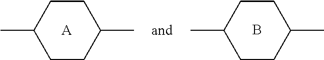
each, independently of one another, denote

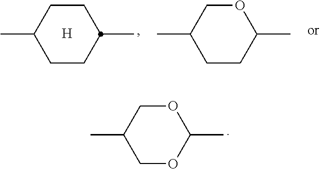

7. LC medium according to claim 1, characterised in that the total concentration of the compounds of the formula II in the LC medium is in the range from 10 ppm to 10,000 ppm.

8. LC medium according to claim 1, characterised in that the compounds of the formula II are selected from the group of the compounds of the formulae I11 to I15,

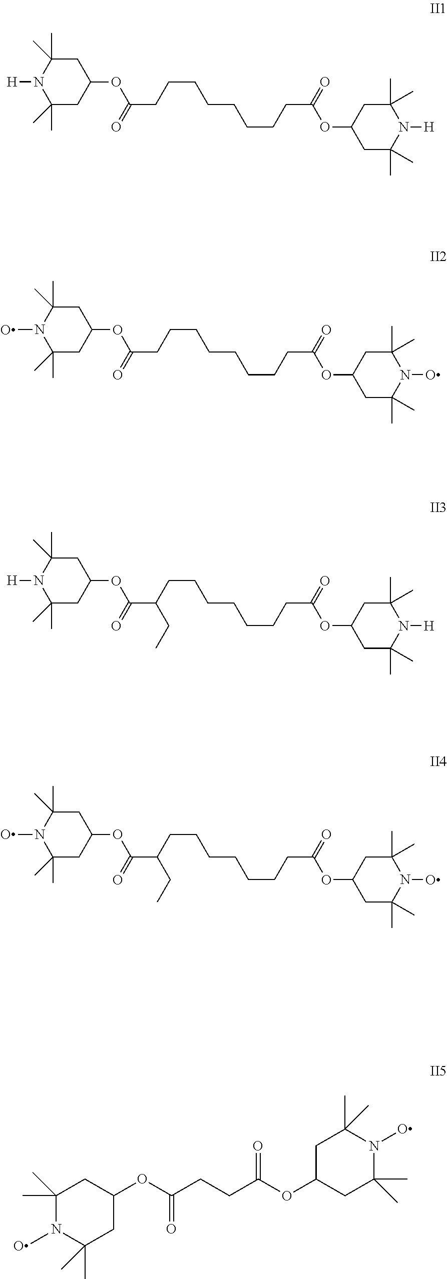

9. LC medium according to claim 1, characterised in that the total concentration of the compounds of the formula I in the medium as a whole is 1% to 25%.

10. An electro-optical device comprising an LC medium according to claim 1.

11. LC display containing an LC medium according to claim 1.

12. Display according to claim 11, characterised in that it is based on the IPS or FFS effect.

13. Display according to claim 11, characterised in that it has an active-matrix addressing device.

14. Process for the preparation of an LC medium according to claim 1, characterised in that one or more compounds of the formula I are mixed with one or more compounds of the formula II and with one or more further mesogenic compounds.
